(19) United States
(12) Patent Application Publication
(10) Pub. No.: US 2025/0356748 A1
(43) Pub. Date: Nov. 20, 2025

(54) ACTIVE DETERRENT PLATFORM

(71) Applicant: ShieldSOS LLC, Austin, TX (US)

(72) Inventor: Joseph Frank Scalisi, Austin, TX (US)

(21) Appl. No.: 19/285,920

(22) Filed: Jul. 30, 2025

Related U.S. Application Data
(63) Continuation-in-part of application No. 19/186,394, filed on Apr. 22, 2025.
Application No. 19/186,394 is a continuation of application No. 19/009,686, filed on Jan. 3, 2025, now Pat. No. 12,400,533.
(60) Provisional application No. 63/570,375, filed on Mar. 27, 2024.

(51) Int. Cl. G08B 15/02; A01M 29/12

(52) U.S. Cl. CPC G08B 15/02; A01M 29/12

(57) ABSTRACT

Included in the present disclosure is a device, including a housing configured to detachably couple to a surface of a building, the housing including a housing exterior and a housing interior therewithin. In some embodiments, the device includes a container housed within the housing interior, the container containing contents therewithin. The device may include at least one housing opening located on the housing exterior. According to some embodiments, the device is configured to discharge the contents from within the container to an area exterior to the housing. The device may be configured to discharge the contents to the area exterior to the housing via at least one housing opening.

### CROSS-REFERENCE TO RELATED APPLICATIONS

The entire contents of the following application are incorporated herein: U.S. Provisional Patent Application No. 63/570,375; filed Mar. 27, 2024; and entitled ACTIVE DETERRENT PLATFORM.

The entire contents of the following application are incorporated herein: U.S. Nonprovisional patent application Ser. No. 19/009,686; filed Jan. 3, 2025; and entitled ACTIVE DETERRENT PLATFORM.

The entire contents of the following application are incorporated herein: U.S. Nonprovisional patent application Ser. No. 19/186,394; filed April 22; and entitled ACTIVE DETERRENT PLATFORM.

### FIELD OF TECHNOLOGY

The present disclosure relates to home security devices. Specifically, the present disclosure relates to deterrence devices and methods.

### BACKGROUND

Home deterrence devices have a rich history dating back centuries, evolving from basic security measures to sophisticated technological solutions. Current smart home technology can often allow homeowners to control security systems remotely through smartphones and computers. These systems integrate various components such as cameras, motion detectors, door/window sensors, and smart locks, providing comprehensive security solutions.

However, current deterrent devices have deficiencies that the present disclosure seeks to remedy.

### SUMMARY

Included in the present disclosure is a device, including a housing configured to detachably couple to a surface of a building, the housing including a housing exterior and a housing interior therewithin. In some embodiments, the device includes a container housed within the housing interior, the container containing contents therewithin. The device may include at least one housing opening located on the housing exterior. According to some embodiments, the device is configured to discharge the contents from within the container to an area exterior to the housing. The device may be configured to discharge the contents to the area exterior to the housing via at least one housing opening.

Included in the present disclosure is a device, including a housing configured to detachably couple to a surface of a building, the housing including a housing exterior and a housing interior therewithin. In some embodiments, the device includes a container housed within the housing interior, the container containing contents therewithin. The device may include a plurality of housing openings located on the housing exterior. According to some embodiments, the device is configured to discharge the contents from within the container to an area exterior to the housing via the plurality of housing openings. Each of the housing openings of the plurality of housing openings may be configured to i) individually spray unique patterns, ii) spray the same pattern, iii) spray customizable patterns, or iv) combinations thereof.

Included in the present disclosure is a device, including a housing configured to detachably couple to a surface of a building, the housing including a housing interior therewithin. In some embodiments, the device includes a container housed within the housing interior, the container containing contents therewithin. The device may include a channel coupled to the container. According to some embodiments, the device is configured to discharge the contents from within the container to an area exterior to the housing. In some embodiments, the channel is configured to facilitate the device discharging the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The housing may include i) a plurality of channels, ii) a branching flowpath channel, or iii) a multipath channel. In some embodiments, the device is configured to discharge the contents from within the container to an area exterior to the housing. According to some embodiments, i) the plurality of channels, ii) the branching flowpath channel, or iii) the multipath channel is configured to facilitate the device discharging the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a channel coupled to the container. In some embodiments, the device is configured to discharge the contents from within the container to an area exterior to the housing. According to some embodiments, the channel is configured to withstand a maximum emission pressure the container emits when the device discharges the contents from within the container to an area exterior to the housing.

Included in the present disclosure is a device, including a housing configured to detachably couple to a surface of a building, the housing including a housing interior therewithin. The device may include an access door located on the housing. In some embodiments, the device includes a container housed within the housing interior, the container containing contents therewithin. The access door may be configured to i) expose, ii) provide access, or iii) combinations thereof to at least a portion of the housing interior. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include an access door coupled to the base. According to some embodiments, the access door is configured to expose at least a portion of the housing interior. The access door may be configured to couple to the base at a secure point, via a coupling mechanism. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include an access door configured to be i) hidden, ii) disguised, or iii) combinations thereof. According to some embodiments, the device is configured to discharge the contents from within the container to an area exterior to the housing.

Included in the present disclosure is a device, including a housing configured to detachably couple to a surface of a building, the housing including base and a housing interior therewithin. In some embodiments, the device includes a container housed within the housing interior, the container containing contents therewithin. The device may include a connection port located at least partially on i) the housing, or ii) the base. In additional or alternative embodiments, the connection port is configured to i) receive an external connection, ii) couple with an internal component, iii) couple an external connector with an internal component, or iv) combinations thereof. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a connection port located at least partially on the access door. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a housing channel located substantially on the housing. According to some embodiments, the housing channel is configured to i) receive an external connection, ii) couple to an internal component, iii) couple the external connection to an internal component, or iv) combinations thereof. In some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a sidewall aperture located on the housing. In additional or alternative embodiments, the sidewall aperture is configured to i) receive a connector, ii) receive an external connection, iii) couple to an internal component, iv) couple the connector to an internal component, v) couple the external connection to an internal component, or vi) combinations thereof. According to some embodiments, the device is configured to discharge the contents from within the container to an area exterior to the housing.

Included in the present disclosure is a device, including a housing configured to detachably couple to a surface of a building, the housing including a base and a housing interior therewithin. In some embodiments, the device includes a container housed within the housing interior, the container containing contents therewithin. The device may include a supplemental base cover configured to detachably couple with i) the base, ii) the housing, or iii) combinations thereof. According to some embodiments, the device is configured to discharge the contents from within the container to an area exterior to the housing.

Included in the present disclosure is a device, including a housing configured to detachably couple to a surface of a building, the housing including a base and a housing interior therewithin. In some embodiments, the device includes a container housed within the housing interior, the container containing contents therewithin. The device may include a supplemental base cover including i) male coupling mechanisms, ii) female coupling mechanisms, or iii) combinations thereof. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a housing passage way located on the housing. In some embodiments, the housing passage way is configured to i) receive an external connection, ii) couple to an internal component, iii) couple the connector to an internal component, iv) couple the external connection to an internal component, or v) combinations thereof. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. The device may include a supplemental base cover detachably coupled to the housing opening. In some embodiments, the device includes a housing passageway located on the housing. According to some embodiments, the device is configured to discharge the contents from within the container to an area exterior to the housing.

Included in the present disclosure is a device, including a housing configured to detachably couple to a surface of a building, the housing including a base and a housing interior therewithin. In some embodiments, the device includes a container housed within the housing interior, the container containing contents therewithin. The device may include a seal located i) at least partially on the base, ii) the housing interior, iii) the housing, or iv) combinations thereof. In some embodiments, the seal is configured to i) receive an external connection, ii) isolate the housing interior from an area exterior to the housing, iii) couple to an internal component, iv) couple an external connection to an internal component, or v) combinations thereof. According to some embodiments, the device is configured to discharge the contents from within the container to an area exterior to the housing.

Included in the present disclosure is a device, including a housing configured to detachably couple to a surface of a building, the housing including a housing interior therewithin. In some embodiments, the device includes a container housed within the housing interior, the container containing contents therewithin. According to some embodiments, the device is configured to discharge the contents from within the container to an area exterior to the housing. The device may be configured to mimic the appearance of a smoke detector.

Included in the present disclosure is a device, including a housing configured to detachably couple to a surface of a building, the housing including a housing interior therewithin. In some embodiments, the device includes a container housed within the housing interior, the container containing contents therewithin. According to some embodiments, the device is configured to discharge the contents from within the container to an area exterior to the housing. The device may be configured to couple to i) a surface, ii) a ceiling, iii) a sidewall, or iv) combinations thereof.

The device may be configured to discharge the contents to the area via at least one housing opening. In some embodiments, the device further includes an actuator configured to discharge the contents from within the container to at least one housing opening via an aperture of the container.

According to some embodiments, the actuator is configured to interact with the container mechanically, electrically, or both, to discharge the contents from within the container. The device may further include a motor configured to move the actuator to enable mechanical interaction between the actuator and the container. In some embodiments, the aperture of the container is aligned with at least one housing opening.

According to some embodiments, the container further includes a container body defining a reservoir therewithin containing the contents. The reservoir may have a capacity from about 0.1 ounce (oz) to about 100 oz. In some embodiments, the container further includes a nozzle extending to at least one housing opening, the nozzle having an outlet opening aligned with at least one housing opening, such that the contents are configured to pass through the nozzle from the reservoir to at least one housing opening. According to some embodiments, the aperture is disposed on the container body and spaced from at least one housing opening, such that the nozzle extends substantially between the aperture and at least one housing opening. The nozzle may include the aperture. In some embodiments, the outlet opening of the nozzle is the aperture.

According to some embodiments, the device further includes a valve stem fluidly coupled with the aperture, wherein the valve stem, the container body, or both, is configured to move between a first position and a second position, wherein in the first position the reservoir is fluidly isolated from at least one housing opening, wherein in the second position the valve stem fluidly couples the reservoir with at least one housing opening. The valve stem, the container body, or both, may move between the first and second positions via the interaction between the actuator and the container.

In some embodiments, the container further includes a cap mechanically coupled to the container body, the valve stem at least partially disposed within the cap, the container body, or both. According to some embodiments, the actuator is configured to move the container body towards the cap so as to move the container body from the first position to the second position, thereby fluidly coupling the reservoir with at least one housing opening. The container may further include a lever mechanically coupled to the container body, wherein the actuator is configured to move the lever toward the container body so as to move the valve stem from the first position to the second position, thereby fluidly coupling the reservoir with at least one housing opening

In some embodiments, the container is pressurized. According to some embodiments, a pressure within the container is from about 25 pounds per square inch (PSI) to about 200 PSI. The device may further include a pump coupled to the container and configured to dispense contents from the container.

The device may further include a heating plate configured to maintain a temperature of i) the contents within the container, ii) the housing interior, or both. In some embodiments, the heating plate includes a metal oxide semiconductor (MOS) heater, a flat plate collector (FPC) heating plate, or both. According to some embodiments, the temperature is maintained above about −10° Celsius (C), −5° C., 0° C., 5° C., 10° C., or 15° C. The heating plate may be limited to less than 40° C.

In some embodiments, the contents are configured to irritate a sensory organ of an individual. According to some embodiments, the contents include a chemical composition. The chemical composition may include capsaicin. In some embodiments, the chemical composition is approximately two million Scoville heat units (SHUS).

According to some embodiments, the chemical composition is configured to aerosolize upon egressing the aperture, at least one housing opening, or both. The aerosolized chemical composition may be configured to remain in the area for a predetermined amount of time. In some embodiments, the predetermined amount of time is from approximately zero minutes to approximately thirty minutes. According to some embodiments, the area is approximately fifteen hundred square feet. The aerosolized chemical composition may be configured to degrade after the predetermined amount of time. In some embodiments, the degradation includes a removal of an irritant to a sensory organ from the area.

According to some embodiments, the housing includes a cover and a base detachably coupled to the cover, the cover and the base substantially enclosing the housing interior. At least one housing opening may be disposed on the cover. In some embodiments, the base is configured to detachably couple to the surface of the building, such that the cover is configured to be removable from the base while the base remains coupled to the surface of the building.

According to some embodiments, the surface is selected from the group consisting of a ceiling of the building, a roof of the building, an exterior wall of the building, an interior wall of the building, and combinations thereof. The container may be removable from the housing. In some embodiments, the container is refillable.

According to some embodiments, the device further includes a printed circuit board (PCB) housed within the housing interior. The PCB may be electrically coupled, communicatively coupled, or both, with the actuator, the motor, or both, such that discharge of the contents from within the container via interaction between the actuator and the container is based on instructions received via the PCB.

In some embodiments, the device further includes a light emitting diode (LED) electrically coupled, communicatively coupled, or both to the PCB, the LED configured to emit a light visible from an exterior of the housing. According to some embodiments, the LED is configured to pulse. The LED may be a first LED, the device further including a second LED.

In some embodiments, the device further includes a speaker electrically coupled, communicatively coupled, or both to the PCB, the speaker configured to emit a noise audible from the exterior of the housing. According to some embodiments, the noise is selected from the group consisting of a siren, a message, and combinations thereof.

The device may further include a camera electrically coupled, communicatively coupled, or both to the PCB, the camera configured to capture an image or video of a location exterior to the housing. In some embodiments, the device further includes a motion detector electrically coupled, communicatively coupled, or both to the PCB, the motion detector configured to capture a movement exterior to the housing. According to some embodiments, the device further includes a microphone electrically coupled, communicatively coupled, or both to the PCB, the microphone configured to capture a sound exterior to the housing. The device may include any combination of these features.

The PCB may be configured to control an action selected from the group consisting of emitting the light from the LED, emitting the noise from the speaker, releasing the contents from the container, capturing the image or video of the location exterior to the housing, capturing the movement exterior to the housing, capture the sound exterior to the housing, and combinations thereof.

In some embodiments, the action is a first action, the PCB further configured to control a second action. According to some embodiments, the PCB is configured to control a sequential order of the first action and the second action. The PCB may be configured to control a delay between the first action and the second action.

In some embodiments, the PCB is configured to control a duration of the action. According to some embodiments, the action is releasing the contents from the container, the duration lasting until the container is approximately empty. The duration may be approximately three seconds. The duration may be greater than three seconds.

In some embodiments, the device further includes a power supply coupled to a component selected from the group consisting of the actuator, the motor, the PCB, the LED, the speaker, the camera, the microphone, the motion detector, and combinations thereof. According to some embodiments, the power supply is sized and configured to fit inside the housing interior. The power supply may be a battery. In some embodiments, the battery is a lithium-ion battery.

According to some embodiments, the power supply is configured to couple to an external outlet. The device may further include a power indicator. In some embodiments, the power indicator is configured to indicate a power state of the power supply.

According to some embodiments, the device is further configured to communicate with an external component. The external component may include a remote computing device. In some embodiments, the remote computing device includes a device selected from the group consisting of a smart device, a tablet computer, a personal assistant, a distributed network of servers, and combinations thereof.

According to some embodiments, the remote computing device is configured to provide instructions for the PCB to control an action, such as those detailed above. The remote computing device may be configured to provide instructions to discharge the contents from within the container to the area exterior of the housing.

In some embodiments, the external component includes a doorbell. According to some embodiments, the external component includes another device of a same type. The device may be configured to communicate with the external component via a wired connection. In some embodiments, the device is configured to communicate with the external component via a wireless connection.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a front view of a building including a deterrence system, according to some embodiments.

FIG. 2 illustrates a front view of a deterrence device, according to some embodiments.

FIG. 3 illustrates a perspective view of the deterrence device of FIG. 2 emitting an aerosol, according to some embodiments.

FIG. 4A illustrates a back view of an interior of a deterrence device, according to some embodiments.

FIG. 4B illustrates an additional back view of an interior of the deterrence device of FIG. 3, according to some embodiments.

FIG. 5A illustrates a back view of an interior of a deterrence device including a heating element, according to some embodiments.

FIG. 5B illustrates a back view of an interior of a deterrence device having another heating element, according to some embodiments.

FIG. 6A illustrates a side view of cross-section of a deterrence device, according to some embodiments.

FIG. 6B illustrates an additional side view of a cross-section of a deterrence device, according to some embodiments.

FIG. 7 illustrates a front view of a hub, according to some embodiments.

FIG. 8 illustrates a block diagram depicting multiple deterrence devices, according to some embodiments.

FIG. 9 illustrates another block diagram depicting multiple deterrence devices, according to some embodiments.

FIG. 10 illustrates a block diagram depicting multiple hubs coupled to multiple deterrence devices, according to some embodiments.

FIG. 11 illustrates another block diagram depicting multiple hubs coupled to multiple deterrence devices, according to some embodiments.

FIG. 12 illustrates a graphical user interface (GUI), according to some embodiments.

FIG. 13A illustrates a front view of a deterrence device, according to some embodiments.

FIG. 13B illustrates a perspective view of a deterrence device, according to some embodiments.

FIG. 14 illustrates a back view of a deterrence device, according to some embodiments.

FIG. 15 illustrates a back view of a deterrence device, according to some embodiments.

FIG. 16 illustrates a perspective view of a deterrence device, according to some embodiments.

FIG. 17 illustrates a perspective view of a deterrence device, according to some embodiments.

FIG. 18A illustrates a perspective view of a deterrence device, according to some embodiments.

FIG. 18B illustrates a perspective view of a deterrence device, according to some embodiments.

FIG. 19A illustrates a perspective view of a building including a deterrence system, according to some embodiments.

FIG. 19B illustrates a perspective view of a building including a deterrence system, according to some embodiments.

### DETAILED DESCRIPTION OF THE INVENTION

Disclosed herein, in some aspects, is a deterrence device configured to disperse contents that may be used to deter a living being (e.g., individual person, and/or an animal) from further encroaching about a given area. The contents may include a composition that irritates a sensory organ of the living being. The deterrence device may store the contents within a container (e.g., a canister), located within a housing of the device.

The deterrence device may be a part of a deterrence system that includes an external component (e.g., a remote computing device) that is communicatively coupled to the deterrence device, and in some cases, is remote from the deterrence device. The external component may be configured to provide instructions to the deterrence device, including discharging the contents from the device, thereby causing the contents to disperse about an area surrounding the device. The device may include one or more additional components, including for example, a camera, motion detector, a microphone, a speaker, or any combination thereof. The device may be configured to send an alert from any of the one or more additional components to the external component, which, in some cases will prompt a user to activate discharge of the contents from the device.

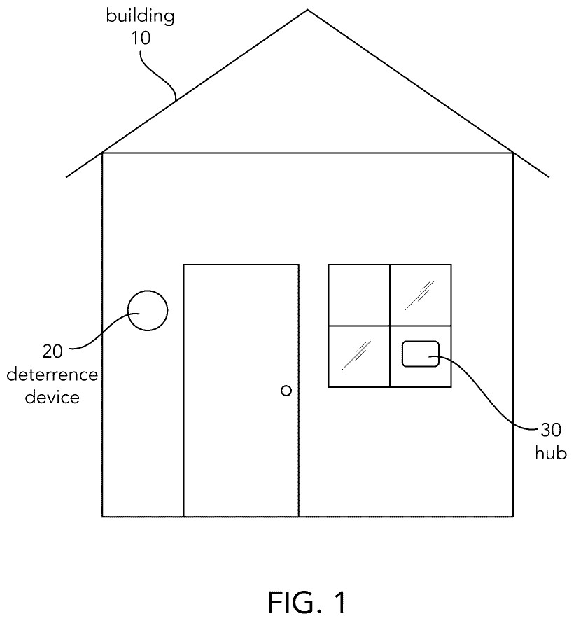

FIG. 1 illustrates a front view of building 10 including a deterrence system, according to some embodiments. As shown in FIG. 1, a deterrence device 20 may be present on an external surface of the building 10. In this embodiment, the deterrence device 20 is shown next to the front door of the building 10, which may be useful when using the deterrence device 20 in tandem with a smart doorbell capable of communicating with the deterrence device 20. In additional or alternative embodiments, the deterrence device may be placed on any walls of the building 10, the roof of the building 10, and/or even an interior surface of the building 10.

Through the window of the building 10, an external component (hub) 30 is shown. As used herein, the term “external component” and “hub” may be used interchangeably. In some embodiments, this hub 30 is placed on an internal surface of the building 10. In additional or alternative embodiments, the hub 30 may be placed on an external surface of the building 10, or not placed on any surface of the building 10, and used as a standalone device which may include a computing device, such as a smart device (e.g., smartphone, smartwatch, tablet, etc).

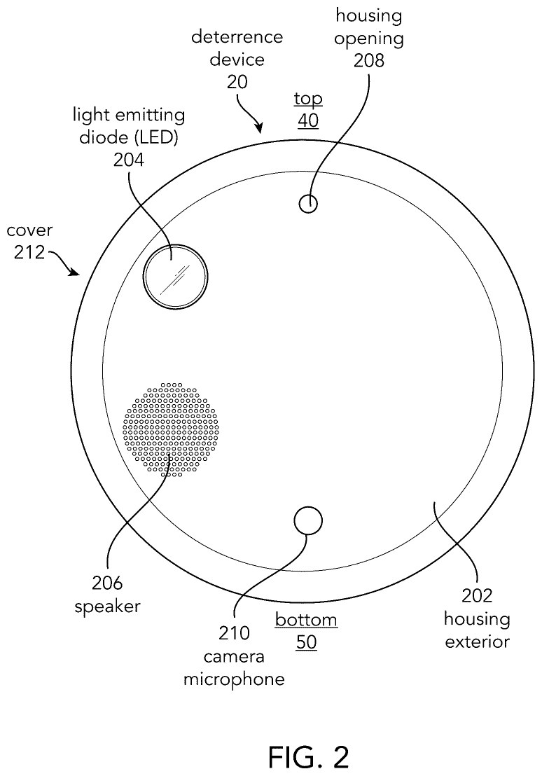

FIG. 2 illustrates a front view of a deterrence device 20, according to some embodiments. As can be seen in FIG. 2, the deterrence device 20 may include a housing having a housing exterior 202. In some embodiments, the deterrence device 20 includes at least one light-emitting diode (LED) 204. The LED 204 may include a color. According to some embodiments, the LED 204 is a multicolored LED, capable of changing colors, or having the color output controlled, either via a controller or a user. In additional or alternative embodiments, more than one LED 204 may be present, and these LEDs may be monochromatic, multicolored, or a combination of these options.

To this extent, colors may be used to convey different information (e.g., warnings, activation of the device, etc.). The colors may also be used for psychological effect. For example, the colors red and blue may be chosen in order to replicate police lights, causing a deterring effect on any would-be intruder or other threat. The LED(s) 204 may also flash, or strobe, which may be jarring to a viewer, and further deter them from staying in the area. In any case, the light emitted from such an LED 204 may be clearly visible from exterior the deterrence device 20.

Also shown in FIG. 2 is a speaker 206. The speaker 206 may be able to play a loud shrill noise, like a siren, or an undulating sound, similar to a tornado warning. The speaker 206 may also play a message, or act as a speaker for a user of the house in order to tell an intruder to leave, and perhaps warning that further deterrence is to follow should the message not be heeded. According to some embodiments, the siren-like noise coming from the speaker 206 may achieve loudness readings of up to 120 decibels (dB). In some embodiments, the message from the speaker 206 may achieve loudness readings of up to 80 dB, in order to convey a message coherently and loudly. In any case, the sound from the speaker 206 may be clearly audible from exterior the deterrence device 20.

The speaker 206 may also operate as a microphone, permitting two-way communication. The microphone may pick up sounds, and if the sound appears abnormal (either in general, or for a time of day), convey this sound to the user (which may include the resident, or other people inside the house), so that they may choose to make a decision based on the sound.

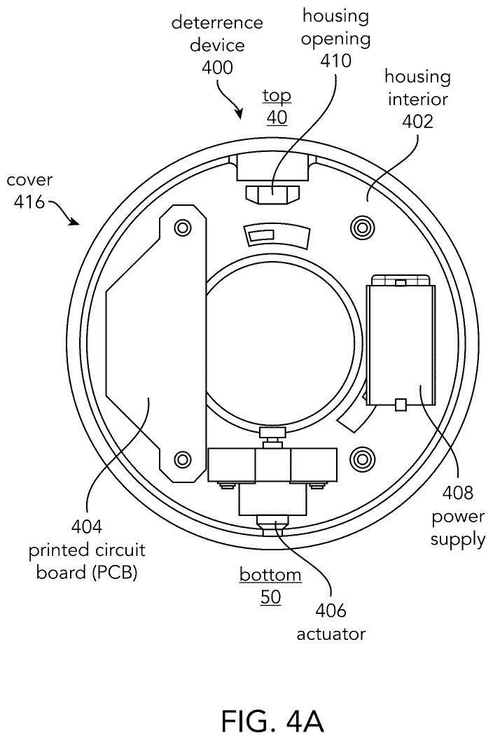

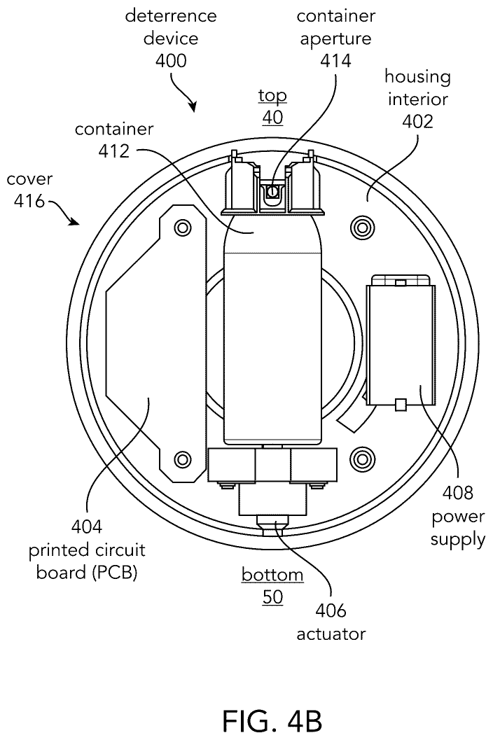

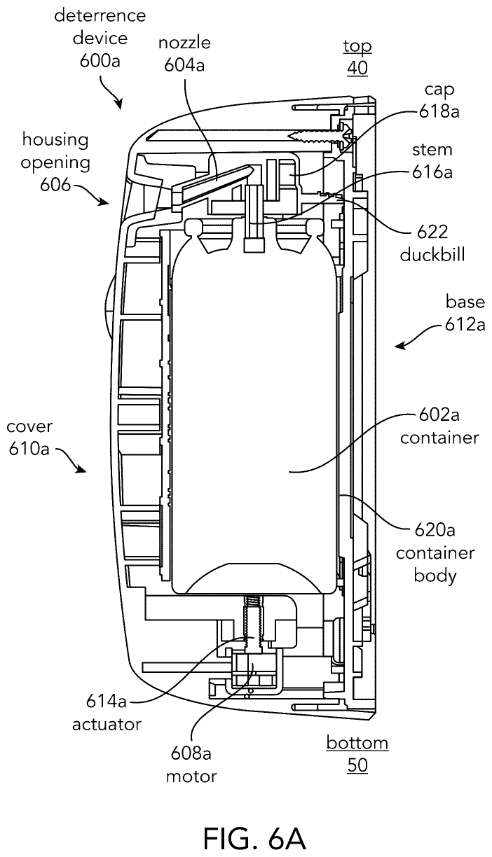

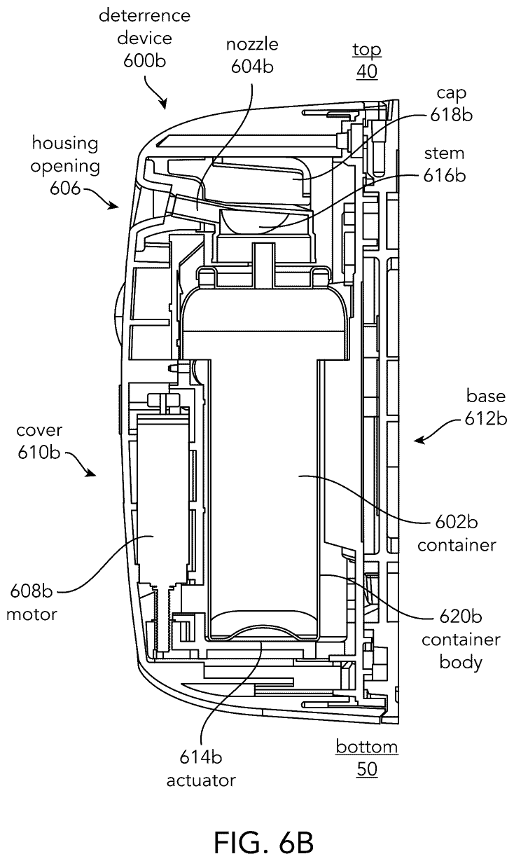

Further shown in FIG. 2 is a housing opening 208. The housing opening 208 may permit the contents of a container stored within the housing to egress the deterrence device 20 (as described herein). FIGS. 4B, 6A, and 6B below detail the fluidic coupling of such a container with a housing opening 208.

Also seen in FIG. 2 is a camera microphone 210. In some embodiments, the camera microphone 210 is only a camera. In additional embodiments, the camera microphone 210 is only a microphone.

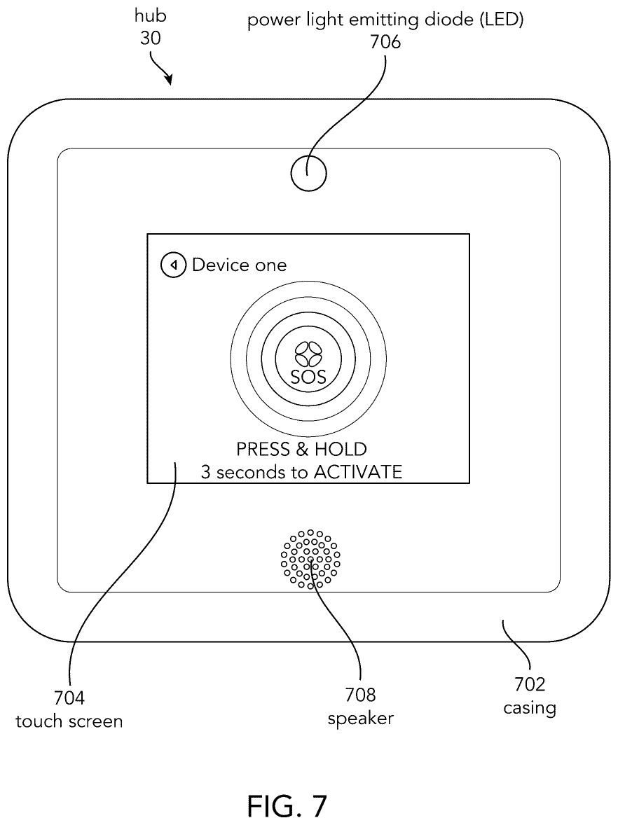

In any embodiments, where the camera microphone 210 includes a camera, the camera microphone 210 may be capable of capturing images. Additionally, or alternatively, the camera microphone 210 may be capable of recording video, or streaming the video directly to a remote device, such as a remote computing device or the external component (hub) (as shown and described in FIG. 7 below).

The camera microphone 210 may be communicatively coupled with a facial recognition database, and capable of conveying information about a passer-by of the device to the user. Additionally, or alternatively, the camera microphone 210 may be capable of causing the deterrence device 20 to perform actions, such as emitting noise from the speaker 206, emitting light from the LED 204, or discharging the contents from the housing opening 208, based on identification of the passer-by.

In additional or alternative embodiments, the camera microphone 210 may be communicatively coupled to an animal database, and capable of conveying information about the animal or taking action based on the animal. For example, if a bear were to approach the building on which the deterrence device 20 is located, the camera microphone 210 may cause the deterrence device 20 to take an action to cause the bear to leave the area based on this information from the database.

In additional or alternative embodiments, the camera microphone 210 may be communicatively coupled to an artificial intelligence (AI) capable of registering items on an individual's person. For example, the AI may see that the individual is holding a gun, and not identify the individual as a police officer or service member, and then cause the deterrence device to take action to cause the individual to leave the vicinity.

In some embodiments, the camera microphone 210 is only a microphone. In any embodiment where the camera microphone 210 includes a microphone, the camera microphone 210 may pick up sounds, and if the sound appears abnormal (either in general, or for a time of day), convey this sound to the resident, or other people inside the house, so that they may choose to make a decision based on the sound.

The housing includes a base (not shown, but shown and described in FIGS. 6A and 6B below) and a cover 212 detachably coupled to the base. The base may be coupled to a surface of the housing (as described herein). The housing exterior 202 may form a portion of the cover 212 of the device. The cover 212 and base, when coupled to each other, define an interior portion that is substantially or at least partially enclosed by the cover 212 and base. The device may include one or more internal components, including a container containing the contents that can be discharged, disposed within the interior portion of the housing.

While not shown in FIG. 2, the deterrence device 20 may also include an additional LED that is configured to indicate the power level of a power supply inside or attached to the deterrence device 20. This LED, or power indicator, may emit a steady light when the power supply is in a high power state. The LED, or power indicator, may emit a blinking light, change the color of light being emitted, or stop emitting light when the power supply is in a low power state, indicating charging or a new battery is needed.

Additionally, and solely to orient the reader, throughout the current specification a top 40 and a bottom 50 of the deterrence device 20 will be provided. The nature of the deterrence device 20 is such that it may be installed on a surface of a building 10 in any orientation, including on a ceiling, such that the uses of “top” and “bottom” are meaningless. However, with respect to the inner workings of the deterrence device 20, it is useful to have an axis of top 40 and bottom 50 to explain where individual components are located with respect to one another.

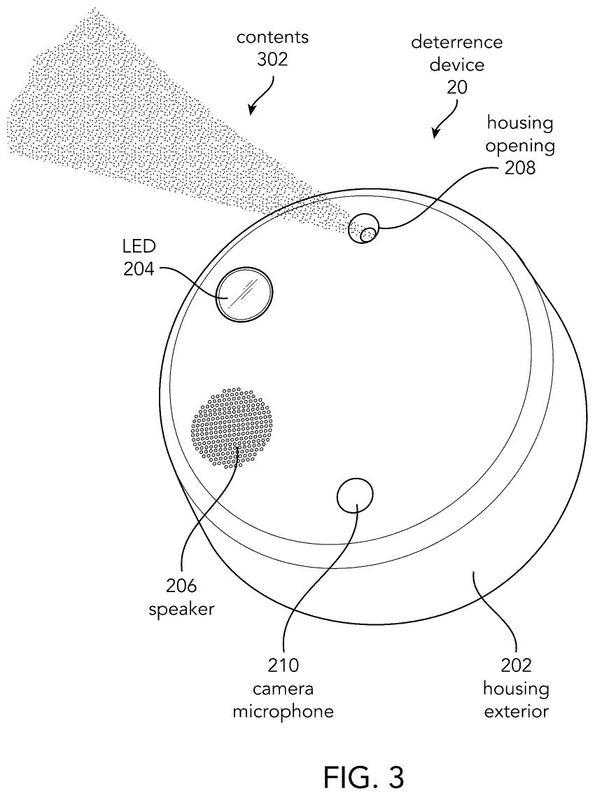

FIG. 3 illustrates a perspective view of the deterrence device 20 of FIG. 2 discharging contents 302 from within the housing. The contents 302 may be discharged as an aerosol, according to some embodiments. The aerosol may include a chemical composition intended to irritate a sensory organ of a living being, such as a person, animal, etc. Stated another way, the chemical composition may be intended to create discomfort in a living being. The contents 302 (e.g., aerosol) may irritate the eyes, lungs, nose, ears, skin, mouth, or any combination thereof, of the living being. In one example, the contents 302 may include or be similar to pepper spray. In some embodiments, the contents 302, once discharged, may be dispersed over an area from about zero to about one hundred square feet, from about one hundred to about five hundred square feet, from about five hundred to about fifteen hundred square feet, from about fifteen hundred to about three thousand square feet, or from about zero to about three thousand square feet.

The contents 302 may linger in the area for between about zero and about five minutes, for between about five and about fifteen minutes, for between about fifteen and about thirty minutes, for between about zero and about thirty minutes before its irritant effect becomes substantially subdued or reduced to having limited effect on the living being. In some embodiments, when the contents' 302 irritant effect becomes substantially subdued or reduced to having limited effect on the living being, it does so without or substantially without leaving behind a residue.

In some embodiments, the chemical composition of the contents 302 includes about ten percent oleoresin capsicum (OC), measuring up to about two million Scoville heat units (SHUS). According to some embodiments, the chemical composition of the contents 302 includes about one and a third percent Capsaicinoids. In additional or alternative embodiments, the contents may include any other type of irritant.

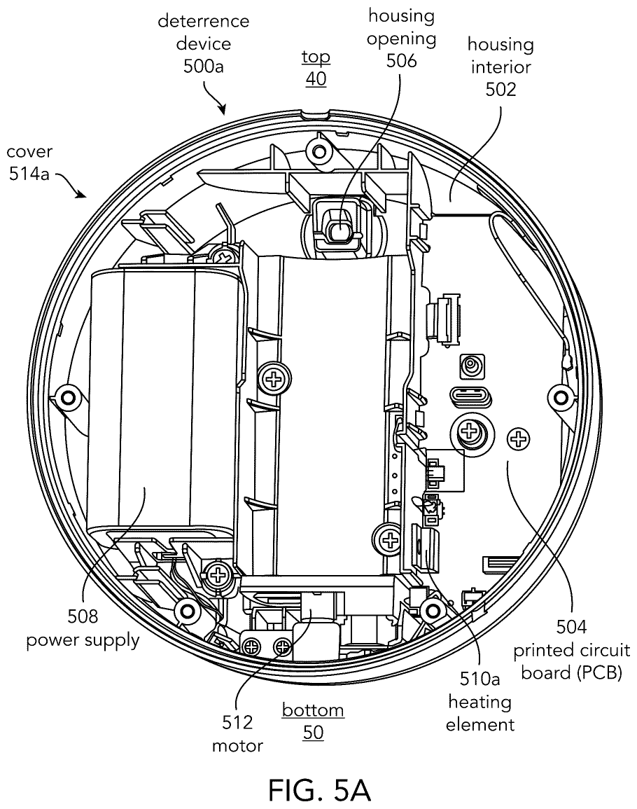

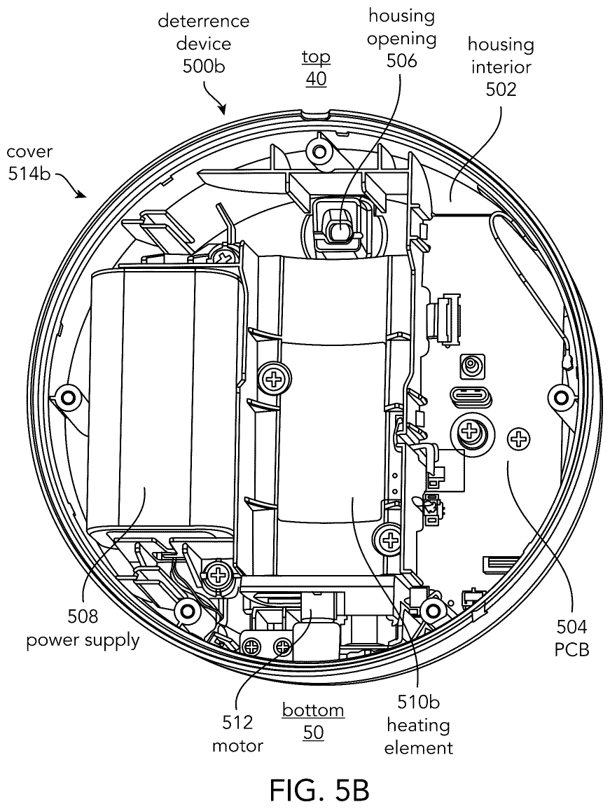

FIG. 4A illustrates a back view of an interior of a deterrence device 400, according to some embodiments. The overall function between deterrence device 400 and deterrence device 20 may be similar, with differences being, for example, location of certain components, such as housing opening 410. The base is removed from the cover 416 in this figure, thereby exposing the interior of the cover 416. As shown in FIG. 4A, the housing of the deterrence device 400 includes a housing interior 402—that is, an interior compartment of the housing in which different components and necessary electronics may be stored. In some embodiments, the deterrence device 400 includes a printed circuit board (PCB) 404. The PCB 404 may be electrically and/or communicatively coupled to any present LED (such as LED(s) 204 as shown and described in FIG. 2 above), any present speaker (such as speaker 206 as shown and described in FIG. 2 above), any present camera and/or microphone (such as camera microphone 210 as shown and described above), any present motor (such as the motor 512 as shown and described in FIGS. 5A and 5B above, the motor 608a as shown and described in FIG. 6A above, and/or the motor 608b as shown and described in FIG. 6B below).

The PCB 404 may also be electrically and/or communicatively coupled to an actuator 406, located near the bottom 50 of the deterrence device. In some embodiments, the actuator 406 is capable of mechanically and/or electrically interacting with a container (as described herein) in order to cause the container to expel its contents. By way of example, the actuator 406 may be capable of exerting up to five pounds of pressure in order to move the container and/or a nozzle of the container about 2.5 millimeters (mm).

Also shown in FIG. 4A is a power supply 408. While FIG. 4A illustrates a power supply 408, it is understood that an external power source may also be used, either directly or indirectly electrically coupled to the deterrence device 400. In some embodiments, the power supply 408 is configured to provide power to any present LED(s) 204, speaker 206, motor (as described herein), and/or actuator 406. According to some embodiments, the power supply 408 is a battery. Specifically, the power supply 408 may be a Lithium-Ion battery, including for example, a three amp-hour (Ah) Lithium-Ion battery.

Additionally, or alternatively, a solar panel may be coupled to the housing of the deterrence device 400. In examples where the deterrence device 400 is coupled to the building 10 outdoors, the solar panel may recharge and/or provide power to the power supply 408.

Additionally, or alternatively, the power supply 408 may be a universal serial bus (USB). For example, the power supply 408 may be a USB type A, USB type B, USB type C, Micro-USB, etc. In some embodiments, the USB may be an external power source. According to some embodiments including a battery as the power supply, the USB electrically couples with the battery to permit charging of the battery and/or permit the USB to provide power to the device without power from the battery. Once the USB is no longer electronically coupled to the power source, the battery may provide power to the deterrence device. In additional or alternative embodiments, the deterrence device is configured to receive pass-through powering via the USB, enabling the battery to provide power to the deterrence device while the USB cable is still coupled to the battery.

FIG. 4A also illustrates a housing opening 410 (similar to the housing opening 208 as shown and described in FIG. 2 above) located near the top 40, from inside the housing interior 402. This opening 410 may fluidly couple the container (as will be explored below in FIG. 4B) to the exterior of the deterrence device 400.

FIG. 4B illustrates an additional back view of an interior of the deterrence device 400 of FIG. 4A, according to some embodiments. The base is removed from the cover 416 in this figure, thereby exposing the interior. Still shown in FIG. 4B and having much the same purposes as those described in FIG. 4A are a PCB 404, actuator 406 located near the bottom 50, and power supply 408 housed within the housing interior 402.

In FIG. 4B, a container 412 is shown inserted into the deterrence device 400 (e.g., within the interior of the housing). This container 412, may include a container aperture 414 located near the top 40 permitting a fluid coupling between the container 412 and the housing opening 410, for allowing the contents of the container 412 to egress the deterrence device 400. The contents of such a container 412 may include an aerosol (such as the contents 302 as shown and described in FIG. 3 above). When the actuator 406 is actuated, the container 412 may release its contents (the aerosol) through the container aperture 414, through the housing opening 410, and into the vicinity around the deterrence device 400.

The container 412 may release all of its contents when the actuator 406 is actuated. In alternative embodiments, the container may only release a percentage of its contents, such as 50% of its contents, so that multiple sprays of aerosol from the container may occur before the need to change the container for a new one. In additional or alternative embodiments, the deterrence device 400 does not include a container but rather a refillable reservoir so the user can add additional aerosol or fluid to be aerosolized under pressure. According to some embodiments, the capacity of the container may be between about 0.1 ounce (oz) to about 100 oz.

Additionally, while not shown in FIGS. 4A and 4B, the deterrence device may include a volume sensor located substantially within the housing interior and configured to detect a volume of aerosol in the container. In some embodiments, the sensor is configured to communicate with an external component (such as the external component shown and described in FIG. 7 below). According to some embodiments, the sensor is configured to send information to the external component regarding the volume of aerosol within the container. For example, the sensor may inform the external component that the aerosol has been emitted, indicating that a new container is needed. In additional or alternative embodiments, the sensor may inform the external component that leakage of aerosol from the container is occurring, and that a replacement container is needed.

FIG. 5A illustrates a back view of an interior of a deterrence device 500a including a heating element 510a, according to some embodiments. The base is removed from the cover 514a in this figure, thereby exposing the interior of the cover 514a. The overall function between deterrence device 500a, deterrence device 400, deterrence device 20 may be similar, with differences being, for example, location of certain components, such as the housing opening 506. As shown in FIG. 5A, the deterrence device 500a includes a housing interior 502 including a housing opening 506 near the top 40 for permitting contents of any present container to escape from the deterrence device 500a. Also seen inside the housing interior 502 is a power supply 508 and a PCB 504 electrically and/or communicatively coupled to multiple other components within the housing interior 502. The power supply 508 and PCB 504 may also be coupled to one another.

Near the bottom 50 of the housing interior 502, a motor 512 is shown. The motor may interact with an actuator (such as the actuator 406 as shown and described in FIGS. 4A and 4B above), or with a container directly in order to cause the container to expel (e.g. discharge) its contents. The motor 512 may be coupled to the power supply 508, the PCB 504, or both.

The deterrence device may include a heating element 510a. The heating element 510a, as shown, may be a metal oxide semiconductor (MOS) heater. The heating element 510a may be coupled to the power supply 508, the PCB 504, or both. The heating element 510a may serve to keep the contents of any present container at an optimal temperature for fluidity and dispersion upon egress from the deterrence device 500a without exceeding a high temperature that could pose a hazard (e.g., not above fifty degrees centigrade). By way of example, if the temperature reaches zero degrees centigrade, the heater may turn on to prevent the internal components of the deterrence device 500a from becoming too cold. In other embodiments, if the temperature reaches sub-optimal temperatures, such as negative ten degrees centigrade, negative twenty degrees centigrade, or lower, the heating plate 510 will be activated. The heating plate 510 may include a sensor to detect a temperature within the interior of the housing. Heating element 510a may be present on a side of the interior portion of the housing where a container may be placed.

Additionally, or alternatively, a solar panel may be coupled to the housing of the deterrence device 500a. In examples where the deterrence device 500a is coupled to the building 10 outdoors, the solar panel may recharge and/or provide power to the power supply 508.

FIG. 5B illustrates a back view of an interior of a deterrence device 500b having another heating element 510b, according to some embodiments. The base is removed from the cover 514b in this figure, thereby exposing the interior of the cover. Deterrence device 500b also includes a housing interior 502 with a housing opening 506 located near the top 40, as well as a PCB 504, power supply 508, and motor 512 located near the bottom 50. The interactions between these components may be the same as those described and shown above in FIG. 5A.

However, in deterrence device 500b, heating element 510b is shown inside the cavity where a container may be placed. This heating element 510b may be a flat plate collector (FPC) heating plate. Heating element 510b may be coupled to the power supply 508, the PCB 504, or both. Heating elements 510b may also serve to keep the contents of any present container at an optimal temperature for fluidity and dispersion upon egress from the deterrence device 500b without exceeding a high temperature that could pose a hazard (e.g., not above fifty degrees centigrade). By way of example, if the temperature reaches zero degrees centigrade, the heater may turn on to prevent the internal components of the deterrence device 500b from becoming too cold. In other embodiments, if the temperature reaches sub-optimal temperatures, such as negative ten degrees centigrade, negative twenty degrees centigrade, or lower, the heating plate 510 will be activated. The heating plate 510 may include a sensor to detect a temperature within the interior of the housing.

Additionally, or alternatively, a solar panel may be coupled to the housing of the deterrence device 500b. In examples where the deterrence device 500b is coupled to the building 10 outdoors, the solar panel may recharge and/or provide power to the power supply 508. In some embodiments, the device may be powered constantly, such as via an alternating current (AC) outlet electrically coupled to the building on which the device is placed. Additionally, or alternatively, a heating pad may be included in or on the device, either alone or in combination with the heating plates as detailed above.

FIG. 6A illustrates a side view of a cross-section of a deterrence device 600a including a cover 610a and a base 612a, according to some embodiments. The base 612a may be the component that attaches to a surface of a building 10. In FIG. 6A, a container 602a is present. The container 602a may include a container body 620a that defines a reservoir containing the contents of the container. The container 602a may further include a cap 618a that is mechanically coupled to the container body 620a. The cap 618a may be located near the top 40 of the deterrence device 600a. The container 602a may further include a valve stem 616a. The valve stem 616a may be configured to access a reservoir of the container 602a (e.g., via actuation by the actuator, as described herein), so as to fluidly couple the container 602a to the exterior of the deterrence device 600a (e.g., via housing opening 606). In some embodiments, the container 602a is fluidly coupled to the exterior of the deterrence device 600a by way of the nozzle 604a and the housing opening 606, and at least partially by way of the valve stem 616a.

In some embodiments, the container aperture (e.g., 414) is on the container body, and/or includes the valve stem 616a, wherein the nozzle 604a is in fluidic communication with the container aperture and/or valve stem 616a. In some embodiments, the nozzle 604a may be, or may have, an aperture, such as the container aperture 414 as shown and described in FIG. 4B above. For example, the nozzle 604a may include an outlet opening that may be the aperture and/or may be in fluidic communication with the aperture. The outlet opening of the nozzle 604a may be aligned with the housing opening 606.

The nozzle 604a is shown oriented in an at least partially downward angle directed away from the top 40. Benefits of such an angle include permitting the cap 618a to be located closer to the top 40, thereby making more room for the container 602a, and/or increasing the possible volume of the contents (e.g., aerosol) that may be provided in the container 602a. Additionally, due to the nozzle 604a facing partially downward, any emitted aerosol would be directed more directly toward the targeted individual and the spray pattern would increase in radius, effecting a greater area.

As described herein, the deterrence device 600a may include a motor 608a, configured to actuate the actuator. The actuator, may be configured to discharge the contents from the reservoir within the container 602a. In some embodiments, the actuator is configured to enable the valve stem 616a to access the reservoir, thereby fluidly coupling the reservoir with the housing opening 606, so as to discharge the contents to an area exterior the deterrence device 600a. The reservoir may be fluidly coupled with the housing opening 606 via the nozzle 604a. In some embodiments, the actuator is configured to move the container body 620a and/or valve stem 616a between a first position and a second position, wherein in the first position, the contents within the reservoir are fluidly isolated from the valve stem 616a and/or housing opening 606, whereas in the second position, the valve stem 616a fluidly couples the contents within the reservoir with the housing opening 606.

At the bottom 50 of the deterrence device 600a, a motor 608a is shown. Benefits of placing the motor 608a in the bottom 50 of the deterrence device 600a include increasing the push limit of the motor, meaning there is a lower power draw on the power supply. Additionally, the motor 608a better equalizes the container from this position. In some embodiments, when the deterrence device 600a is activated to spray the aerosol from the container 602a, the motor 608a will cause the actuator 614a to move upward, applying pressure to the container 602a, and thereby moving the container body 620a upwards. As pressure is applied to the container body 620a, the cap 618a is held in place by the housing of the deterrence device 600a. The container body 620a transfers at least part of this pressure to the valve stem 616a, causing the valve stem 616a to at least partially access the reservoir. The contents (e.g., aerosol), which is itself pressurized within the container 602a, is then released from the container 602a through the valve stem 616a, through the nozzle 604a, and out of the housing opening 606. According to some embodiments, the pressure may be between about 25 pounds per square inch (PSI) and about 200 PSI.

Additionally, or alternatively, the valve stem 616a may be in constant fluid communication with the contents of the container 602a, but the surrounding pressure is enough to keep the valve stem in a closed state. When the pressure is applied to the container body 620a, pressure is exerted on the valve stem in a direction transverse to the surrounding pressure, causing the valve stem 616a to at least partially open, and allowing the contents to be released from the container 602a through the valve stem 616a, through the nozzle 604a, and out of the housing opening 606.

Also seen in FIG. 6A is a duckbill 622 coupled to the cap 618a. The duckbill 622 may allow a user to more easily remove and/or place containers 602a into the deterrence device 600a, while also at least partially preventing any problems from occurring with respect to handling highly pressurized aerosols and their containers.

FIG. 6B illustrates a side view of a cross-section of another deterrence device 600b including a cover 610b and a base 612b, according to some embodiments. The base 612b may be the component that attaches to a surface of a building 10. In FIG. 6B, a container 602b is present. The container 602b may be similar in function to that of container 602a, with a few exceptions as described herein. The container 602b may include a container body 620b having a reservoir containing the contents, a valve stem 616b, and optionally a cap 618b and a nozzle 604b.

The nozzle 604b may be, or may have, an aperture, such as the container aperture 414 as shown and described in FIG. 4B above. The nozzle 604b is shown oriented in an at least partially upward angle towards the top 40. Benefits of such an angle include lowering the cap 618b with respect to the top 40, thereby decreasing the volume of the container 602b, and thereby decreasing the weight of the container 602b along with its contents. This in turn allows the actuator 614b to apply the necessary pressure to open the valve stem 616b using less force, and therefor, less power provided by any present power supply. According to some embodiments, the pressure may be between about 25 PSI and about 200 PSI.

The motor 608b may be configured to actuate the actuator 614b, similar to the motor 608a in FIG. 6B. The motor 608b is shown disposed near the front of the cover 610b of the deterrence device 600b. When the deterrence device 600b is activated to spray the contents (e.g., aerosol) from the container 602b, the motor 608b will cause the actuator 614b, shown near the bottom 50 of the deterrence device 600b, to move upward, applying pressure to the container body 620b, as similarly described in FIG. 6A.

While not shown in FIGS. 6A and 6B, the nozzle may extend at a right angle to the cap, and not at an upward or downward angle with respect to the top. In such an embodiment, this may serve to find a middle ground between the benefits of the other designs.

As described herein, any deterrence device described herein may be configured to communicate with an external component. The external component may be a remote computing device, which may include any of a smart device, a tablet computer, a personal assistant, a doorbell, and a distributed network of servers. In some embodiments, the device is configured to communicate with the external component via the PCB (as described herein). Alternatively, or additionally, individual components of the deterrence device (e.g., actuator, motor, LED, camera, speaker, microphone, motion detector, etc.) are configured to communicate with the external component. In some embodiments, the device (PCB and/or individual components) includes a communications chip configured to communicate with the external component.

In some embodiments, the external component is configured to provide instructions to the PCB and/or individual components to initiate and/or control an action. In some embodiments, the action includes discharging the contents from the container to the area surrounding the exterior of the deterrence device, capturing an image via the camera, recording a sound via the microphone, emitting a noise via the speaker, emitting a light via the LED, or any combination thereof. The external component may be configured to selectively and/or simultaneously initiate and/or control an action described herein. This includes the external component being configured to sequentially initiate and/or control an action of a component of the deterrence device.

In some embodiments, the external component is configured to receive an alert from any deterrence device described herein, wherein the alert may correspond to an intruder or dangerous or unwanted animal about a building. In response to the alert, the external component may be configured to activate a deterrence measure via the deterrence device. The deterrence measure may include discharging the contents from within the container to the exterior surrounding the housing, emitting light from the LED, emitting noise from the speaker, capturing images via the camera, or any combination thereof.

The alert may include light being emitted from the LED, sound received by the microphone, movement captured by the motion detector, image captured by the camera, or any combination thereof. In some embodiments, the external component is configured to automatically activate the deterrence measure, which may include the use of, for example, a machine learning algorithm. Additionally, or alternatively, the external component may be configured to activate the deterrence measure based on a user input. For example, the user may be prompted, via an external component, upon receiving an alert, to activate a deterrence measure. In some embodiments, the user may select a zone within the region of visibility attainable by the camera, configured to define an area that the external component monitors. The user may also configure the different settings for the zone such as, but not limited to, the deterrence device activating when the external component detects an action (e.g., movement), within the defined area(s) for the respective zone(s).

As described herein, the external component (hub) may include a remote computing device, including a smart device. FIG. 7 illustrates a front view of a hub 30, according to some embodiments. As shown in FIG. 7, the hub 30 includes a casing 702 for holding the contents and/or electronics of the hub 30. The hub may also include a touch screen 704 capable of being interacted with by a user. As described herein, the hub 30 may be communicatively coupled to the deterrence device 20, such that the deterrence device may be activated through interactions with the hub 30.

The hub 30 may be able to control any present LED(s) (such as LED 204 as shown and described in FIG. 2 above), any present speaker (such as the speaker 206 as shown and described in FIG. 2 above), any present camera or microphone (such as camera microphone 210 as shown and described in FIG. 2 above), any present actuator (such as the actuator 406 as shown and described in FIGS. 4A and 4B above), and/or any present motor (such as the motor 512 as shown and described in FIGS. 5A and 5B above, the motor 608a as shown and described in FIG. 6A above, and/or the motor 608b as shown and described in FIG. 6B above), either individually or simultaneously. A user may also preprogram a sequence of activations for these components including setting a delay between actions in order to permit an intruder to leave prior to escalating the deterring effects.

Also shown in FIG. 7 is a power LED 706. The power LED 706 may indicate that the hub 30 has power. The power LED 706 may also indicate that the hub 30 is running out of power through dimming, changing color, or blinking. In some embodiments, the hub 30 does not include a power LED 706, and instead, the touch screen 704 may indicate a power level, or lack thereof, through dimming or flashing.

As described herein, the hub 30 may also provide information to the user. For example, the hub 30 may convey any and all information gathered by any present camera, microphone, or motion detector, along with information associated with this gathered data in combination with any databases being used or AI detection. The hub 30 may also be capable of informing a user when the space (e.g., area exterior to the deterrence device) is clear (aerosol has dissipated/deteriorated enough to be safe) after an emission of the aerosol. This may occur through a preprogrammed timer with respect to an estimated time of dispersion. This may also occur through an integrated sensor capable of monitoring the percent composition of the ambient air that is still made of the aerosol's chemical composition, such as by way of parts per million (PPM).

As described herein, the features provided by the hub 30 may also be integrated into a remote computing device (e.g., a smart device, a phone, a tablet, a laptop, etc.). This may permit a user to forego the use of a dedicated hub 30 in favor of using a device they already have at hand. The features may be provided via a non-transitory, computer-readable media executable by a processor of a computing device as well, permitting the code needed to run the features of the hub 30 to be integrated into computing devices at need.

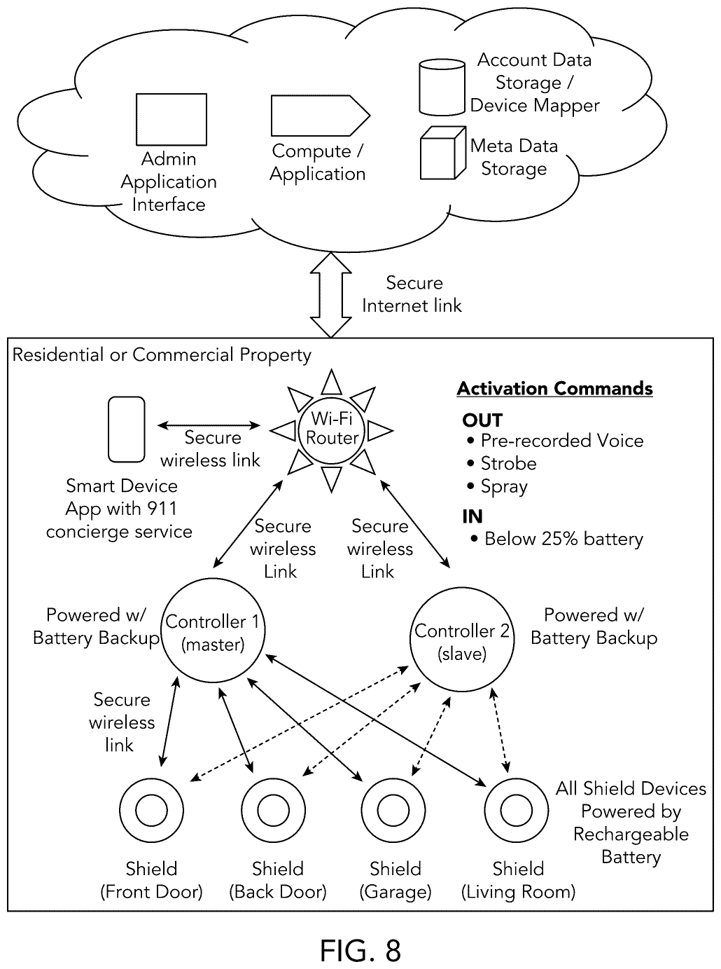

FIG. 8 illustrates a block diagram depicting multiple hubs coupled to multiple deterrence devices (e.g., any deterrence device described herein), according to some embodiments. Specifically, FIG. 8 illustrates two controllers (also referred to as hubs 30) communicatively coupled to multiple shields (also referred to as deterrence device 20). In this example, four shields are illustrated. In other embodiments, as few or as many shields as desired may be implemented. Additionally, only two controllers are shown in this embodiment. In additional embodiments, as few or as many controllers as desired may be implemented.

In FIG. 8, one controller acts as a master, while the other controller acts as slaves-meaning the first controller (master) is directly interacted with by a user, while the second controller may receive and duplicate the instructions given to the first controller. As shown, both controllers are communicatively coupled to all shields. In additional embodiments, the controllers are communicatively coupled to distinct shields. In still additional embodiments, the controllers are communicatively coupled to some, but not all, of the shields, and overlap in communication between the controllers and some of the shields is permitted. This communicative coupling may be through a secure wireless link.

A user may interact directly with the controller, or with a remote computing device, such as the smart device as shown. In the example of using a remote computing device, the user may communicate with the controllers by way of a wireless fidelity (Wi-Fi) router. In this way, a user can control the entire system over Wi-Fi.

Also shown in FIG. 8 are possible commands to and from the system. The system may output a pre-recorded voice through the speaker, strobing lights through the LEDs, and discharge the contents from the container. The shields or controllers may inform a user through their remote computing device that power levels are low, such as below 25%.

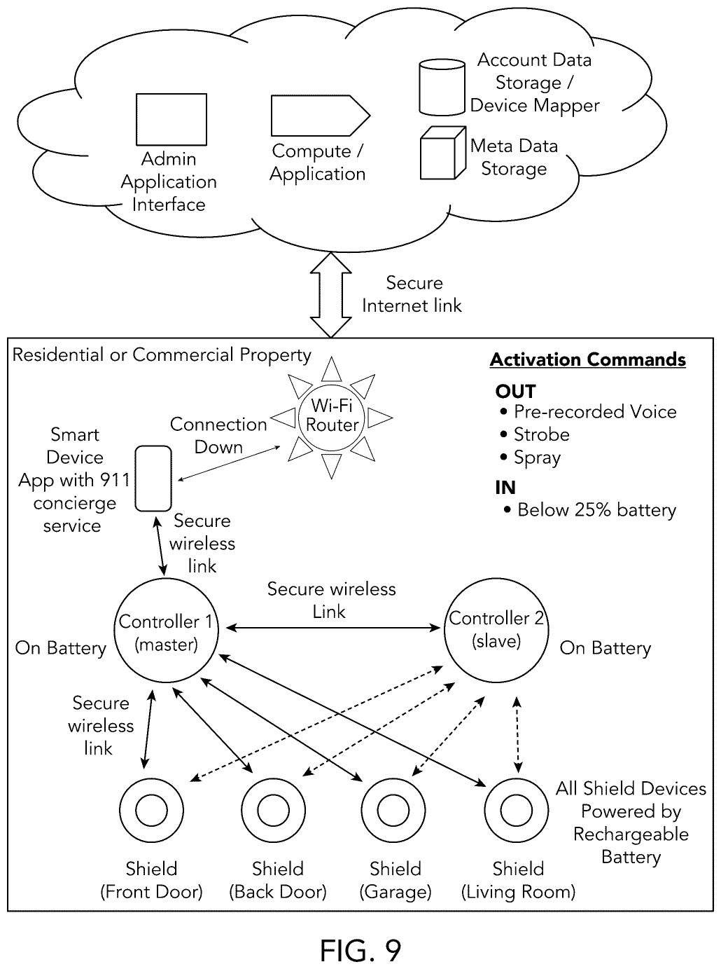

FIG. 9 illustrates another block diagram depicting multiple hubs coupled to multiple deterrence devices, according to some embodiments. As shown in FIG. 9, there may be times when the Wi-Fi router cannot be accessed-either the internet is down, or reception in the area is not great, etc. In such instances, a user may communicate with a controller via their remote computing device (e.g., a mobile phone or other wired, or wireless, device, etc.) through a short-range communications network, such as Bluetooth. The user would need only communicate with the master controller, as the slave controller may be wirelessly communicatively coupled in the same manner to the master controller in order to receive instructions.

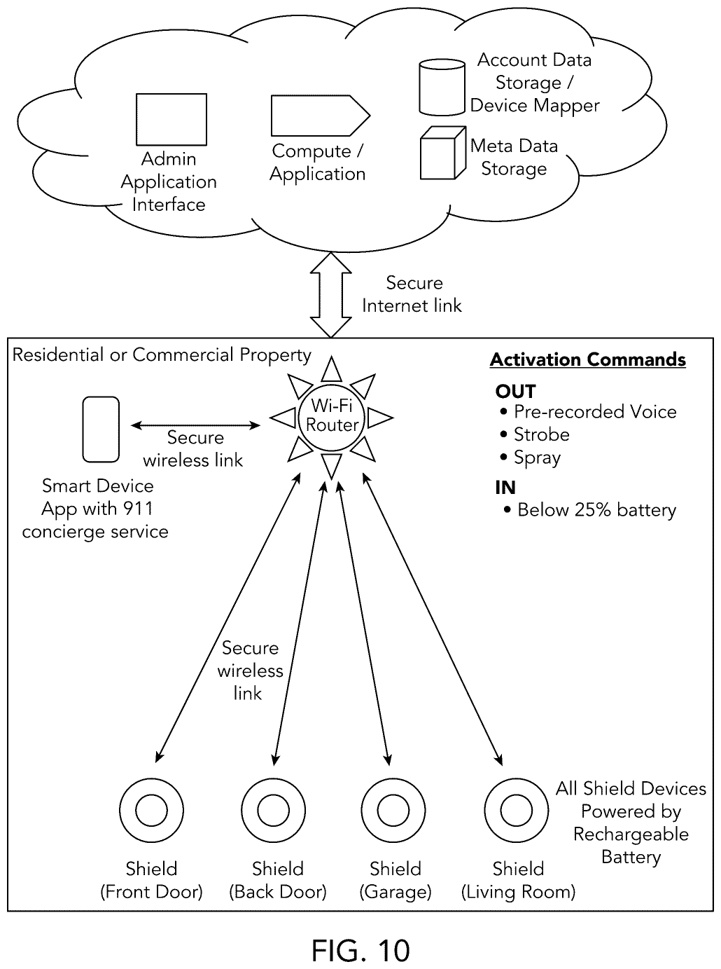

FIG. 10 illustrates a block diagram depicting multiple deterrence devices, according to some embodiments. Specifically, FIG. 10 as illustrated removes the controllers from FIG. 8, instead permitting the user to directly interact with each shield through a Wi-Fi connection on a remote computing device. In such embodiments, the user may individually control each shield with their remote computing device.

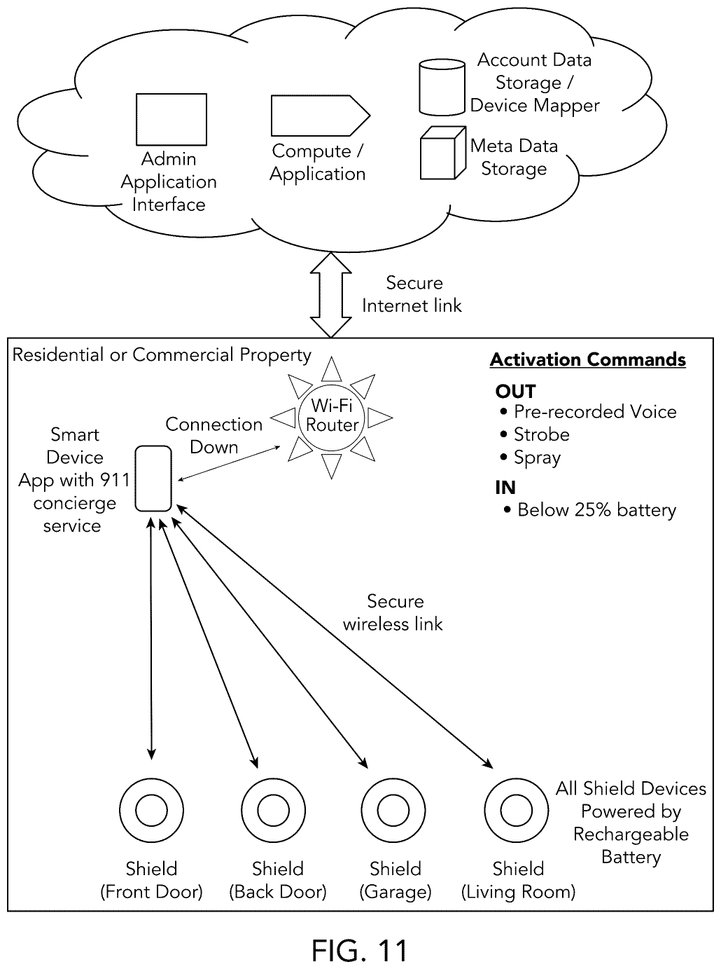

FIG. 11 illustrates another block diagram depicting multiple deterrence devices, according to some embodiments. Similar to FIG. 9 above, this embodiment shows a Wi-Fi connection being unattainable. In such cases, the user may communicate with each included shield through a short-range communications network, such as Bluetooth. In this embodiment, the user may be able to independently communicate with and control each shield.

In each of the illustrations depicted in FIS. 8-11, the external component (hub, controller) may be communicatively coupled to each of the individual deterrence devices (shields), which may be any deterrence device described herein. The external component may further be configured to independently control, simultaneously control, or both, an action for each of the deterrence devices. For example, upon receiving an alert from a specific location of a building, a user may be able to selectively discharge the contents from the container for the deterrence device(s) located in the closes proximity to said specific location. Similarly, the user may be able to simultaneously discharge the contents from the container for all the deterrence devices.

In some embodiments, the deterrence device includes, or is operatively and communicatively coupled with, a computational module. The computational module may be capable of causing the deterrence device to perform actions (e.g., emitting sound, flashing lights, emitting aerosol, etc.) without receiving inputs from a user.

The computational module may be capable of being trained, i.e., learning from the user. For example, if an animal, such as a bear, approaches the user's house, the user may choose to take softer actions at first before releasing the aerosol (e.g., contents from the deterrence device). Maybe the user turns on the LEDs and has them strobe for a period of time before adding in a siren from the speaker for a period of time and then releasing the aerosol. In such an example, the computational module may learn this pattern of actions, and should the system as a whole recognize a bear approaching in the future, repeat this sequence of actions.

As another example, the user may react to specific noises reported by the system. Maybe a suspicious noise occurs near their door, and as a preemptive measure they turn on the LEDs as a warning. Even if no further action is taken, the computational module may learn this pattern and recognize the same, or similar, noises and repeat the actions taken by the user. These same processes may occur for motion that is detected, or AI and facial recognition of either individuals or objects associated with the individuals.

In some embodiments, the computational module, via for example the camera, may be configured to identify if a dangerous object, such as a weapon (e.g., gun, knife) is present with an individual, and thereby automatically discharge the contents from the container from a deterrence device.

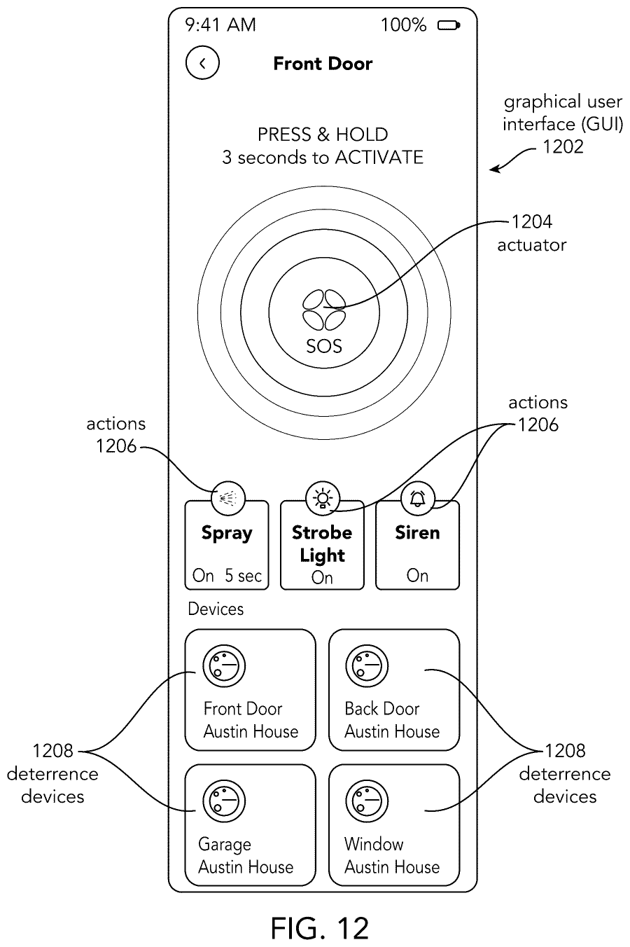

FIG. 12 illustrates a graphical user interface (GUI) 1202, according to some embodiments. The GUI 1202 may be capable of being presented on the hub 30, or a remote computing device accessible by a user. In some embodiments, the GUI 1202 includes an actuator 1204 for causing any communicatively coupled deterrence devices 1208 to perform actions 1206. Actions 1206 shown on the GUI 1202 include discharging the contents from the deterrence device, strobing a light, and sounding a siren. As can be seen on the spraying action 1206, a timer may also be present. This time may also be present on the strobing a light and sounding a siren actions 1206, allowing the user to customize their choice of deterrence.

Also seen in FIG. 12 are multiple deterrence devices 1208. These deterrence devices 1208 may be any of the deterrence devices 20, 400, 500a, 500b, 600a, and/or 600b as detailed throughout the disclosure above. A user may be able to change which deterrence device 1208 they are currently interacting with and/or sending instructions to. In this way, the user may be able to isolate the deterrence to a specific location within their building, or, even a location in a different building that has a deterrence device in it. The user may also be able to select multiple deterrence devices 1208 in order to maximize coverage. This may be useful in instances where a group of people are trying to break into a building from multiple points of entry, so that the user does not need to individually set off each distinct deterrence device 1208.

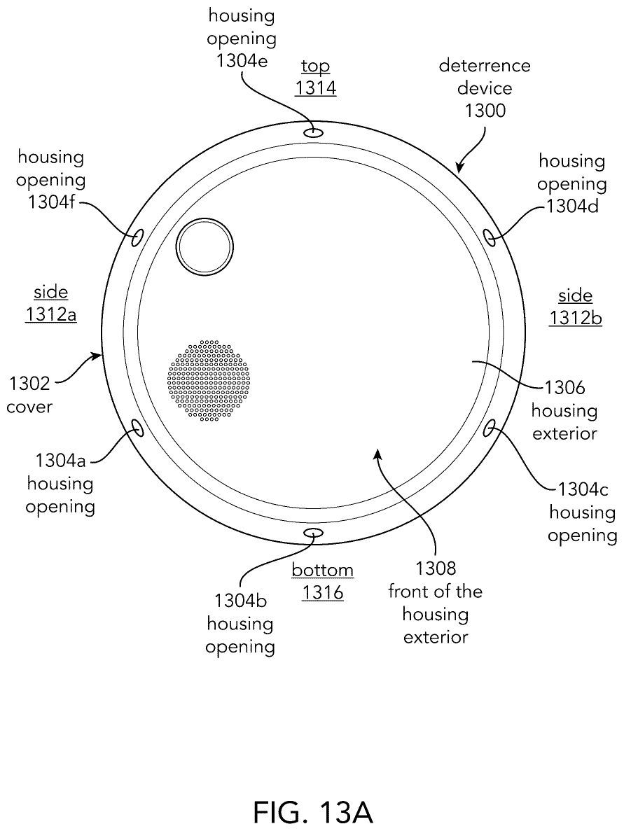

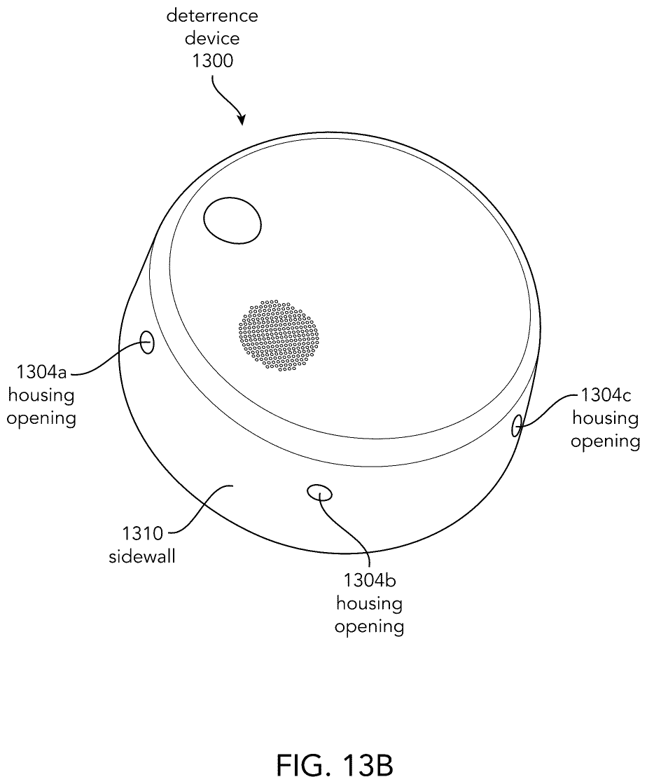

FIG. 13A illustrates a front view of the deterrence device 1300, according to some embodiments, and FIG. 13B illustrates a perspective view thereof. In the embodiment as shown in FIG. 13A, the deterrence device 1300 may include a cover 1302, including a housing opening(s) 1304. The housing opening(s) 1304 may include a plurality of housing opening(s), such as those indicated by 1304a, 1304b, 1304c, etc. In some embodiments, the housing opening(s) 1304 are located substantially along and/or about the housing exterior 1306, such as a sidewall extending 1310 about the perimeter and/or substantially perpendicular to a front 1308 of the housing exterior 1306. The sidewall may include a side(s) 1312, a top 1314, and/or a bottom 1316 of the deterrence device 1300. In additional or alternative embodiments, the housing opening(s) 1304 are located near the top 1314 of the deterrence device 1300, the bottom 1316 of the deterrence device 1300, and/or either side 1312 of the deterrence device 1300. Additionally, or alternatively, a greater (or lesser) number of housing opening(s) 1304 may be placed about the cover 1302 and/or housing exterior 1306 of the deterrence device 1300.

In some embodiments, the deterrence device 1300 is configured to spray in a pattern, such as a flat, a fan, a solid stream, a full cone, a hollow cone, a mist, a frisbee, a fine, an atomizing, an axial, a deflector, and/or a fog pattern. In additional or alternative embodiments, the deterrence device 1300 is configured to spray individual and potentially disparate patterns from distinct housing opening(s) 1304. In some embodiments, the spray patterns of each and every housing opening(s) 1304 are configurable such that the housing opening(s) 1304 spray individual and potentially disparate patterns or identical patterns. Additionally, or alternatively, each of the housing opening(s) 1304 may be capable of spraying unique spray patterns. In some embodiments, each of the housing opening(s) 1304 spray patterns are individually customizable. The deterrence device 1300 may be configured to spray in a flat spray pattern when coupled to a ceiling or a roof line. In still additional embodiments, the individual housing opening(s) 1304 are configured to spray in the same pattern.

The deterrence device 1300 may include a channel coupled to the container (as shown and described in FIG. 4B). In some embodiments, the channel is a plurality of channels. In additional or alternative embodiments, the channel is configured to fluidly couple with the container. The channels may be configured to fluidly couple with a container aperture (as shown and described in FIG. 4B). The channels may be configured to fluidly couple with a nozzle (as shown and described in FIG. 6A). In some embodiments, the channels are configured to fluidly couple with at least a housing opening(s) 1304. In additional or alternative embodiments, the channels are a single channel configured to fluidly couple to each of the housing opening(s) 1304. The single channel may be configured to fluidly couple to a plurality of nozzles. In some embodiments, the single channel is configured to fluidly couple to the container aperture. The single channel may be configured to fluidly couple with the container.

Additionally, or alternatively, the channels may be configured to fluidly couple a housing opening(s) 1304 to the container aperture. The channels may be configured to couple the container to at least a housing opening(s) 1304. In some embodiments, the container is fluidly coupled to each of the housing opening(s) 1304 by way of the nozzle at each of the housing opening(s) 1304, by way of a branching flow path (for example). In additional or alternative embodiments, the container aperture is configured to permit fluid coupling between the container and a housing opening(s) 1304 to allow the contents of the container to egress the deterrence device 1300. In some embodiments, a housing opening(s) 1304 is fluidly coupled to the container aperture, allowing the contents of the container to egress the deterrence device 1300 at a housing opening(s) 1304. The channel (or channels) may fluidly couple the container to each of the housing opening(s) 1304, and the channel(s) may permit the contents of the container to egress the deterrence device 1300 at each of the housing opening(s) 1304. In additional or alternative embodiments, the nozzle may be a multi-chamber nozzle, with each chamber of the nozzle individually fluidly coupling to a distinct flow path, and thereby a distinct housing opening(s) 1304, enabling the fluid coupling of contents of the container to each of the housing opening(s) 1304. In some embodiments, the single channel is configured to fluidly couple the container to the plurality of nozzles. Additionally, or alternatively, the single channel may be configured to fluidly couple the container to each of the housing opening(s) 1304.

In some embodiments, the channel(s) are configured to form a multipath channel. The multipath channel may be configured to fluidly couple with a housing opening(s) 1304. In some embodiments, the multipath channel is configured to fluidly couple with the container. In additional or alternative embodiments, the multipath channel is configured to fluidly couple with the container and at least a housing opening(s) 1304. The multipath channel may be configured to facilitate the egression of the contents of the container to at least a housing opening(s) 1304. In some embodiments, the multipath channel is configured to fluidly couple to at least a nozzle. In additional or alternative embodiments, a multipath channel may be configured to fluidly couple with a plurality of nozzles. The multipath channels may be configured to fluidly couple to a housing opening(s) 1304 located on the cover 1302, the housing exterior 1306, the front of the housing exterior 1307, or any combinations thereof. In some embodiments, the multipath channel is configured to fluidly couple the container to each of the housing opening(s) 1304.

In additional or alternative embodiments, the channels are configured to withstand the pressure the container emits when egressing the contents of the container to at least a housing opening(s) 1304. In additional or alternative embodiments, the pressure the container emits is a maximum emission pressure. The channels may be configured to withstand the maximum emission pressure. In some embodiments, the cross-sectional diameter of the channels may be modified such that the pressure of the contents of the container when emitted through each housing opening(s) 1304 is substantially equal to one another, as well as substantially equal to the pressure emitted in embodiments including only a single housing opening(s) 1304. By way of example, the cross-sectional diameter may be narrowed, and/or the cross-sectional diameter may taper as the fluid path approaches each opening and/or point of egress from the housing opening(s) 1304. Narrowing of the fluid path may increase the pressure of the contents when expelled.

In additional or alternative embodiments, the channel(s) are located in the cover 1302. The channel(s) may be built into the housing interior of the deterrence device 1300. In some embodiments, the channel(s) may be molded in the housing interior of the deterrence device 1300. In additional or alternative embodiments, the channel(s) couple the container to four housing opening(s) 1304a, 1304b, 1304c, and 1304d. The channel(s) may be configured to couple the container to five or six housing opening(s) 1304a, 1304b, 1304c, 1304d, 1304e, and 1304f. Additionally, or alternatively, the channel(s) may be tubes individually connect each of the housing opening(s) 1304 to the container. The tubes may be configured to fluidly couple the container to each of the housing opening(s) 1304. In some embodiments, the tubes are configured to fluidly couple the container to at least a nozzle. In additional or alternative embodiments, the channel(s) are made of a moldable material. In some embodiments, the channel(s) are made of a manipulatable material. For example, the deterrence device may be injection molded, and the channel(s) thereby formed via the injection molding process. Additionally, or alternatively, the channel(s) may be made of a polymer, synthetic polymer, semi-synthetic polymer, carbon fiber, composites, metals, transition metals, metalloids, post-transition metals, or alloys. In some embodiments, the channel(s) are made of aluminum.

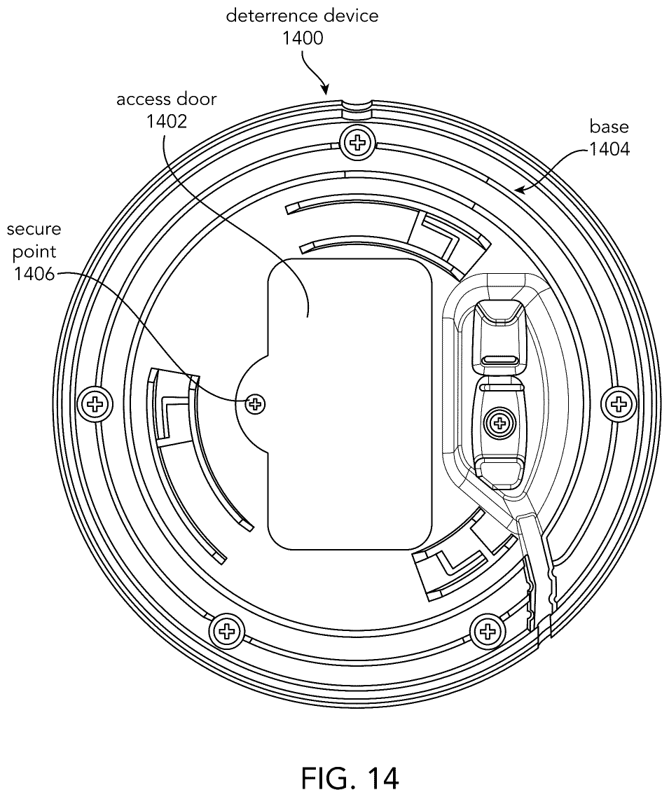

FIG. 14 illustrates a back view of a deterrence device 1400, according to some embodiments. In the embodiment as shown in FIG. 14, the deterrence device 1400 may include an access door 1402 coupled to the base 1404. The access door 1402 may hingedly couple, rotatably couple, slidably couple, or mechanically couple with the base 1404. Additionally, or alternatively, the access door 1402 may be configured to allow a user to access at least a portion of the housing interior of the deterrence device 1400 (as shown and described in FIG. 4A). The access door 1402 may be entirely removed from the deterrence device 1400. In some embodiments, the access door 1402 is configured to expose at least a portion of the housing interior. In additional or alternative embodiments, the access door 1402 is configured to expose at least a portion of the interior compartment of the housing without needing to remove the base 1404 from the cover.

Additionally, or alternatively, the access door 1402 may be located near one or more internal components (e.g., the container, PCB, USB, battery, etc.) permitting access to at least at least a portion of the one or more internal components without the need to remove the base 1404 from the cover. According to some embodiments, the access door 1402 is located near the container (as shown and described in FIG. 4B) and configured to expose at least a portion of the container.

In some embodiments, the access door 1402 is configured to be disposed over an access opening in the base 1404, where said access opening may be configured to facilitate providing access to an internal component. For example, the access opening may be configured to provide easy access to the container and permit a user to swap the container through the access opening. In some embodiments, the access door 1402 is sized to receive an internal component, such as the container, therethrough. In still additional or alternative embodiments, the access door 1402 may replace the base 1404 and couple to the cover at a hinge permitting access to at least a portion of the interior compartment of the housing. In additional or alternative embodiments, the access door 1402 is configured to provide easy access into the interior portion of the housing without the need to remove the cover from the base 1404.

In some embodiments, the access door 1402 is configured to securely couple with the base 1404. The access door 1402 may be configured to securely couple to the base 1404 at a secure point 1406. In additional or alternative embodiments, the access door 1402 securely couples with the base 1404 using coupling mechanism such as, a screw, a bolt, a fastener, a rivet, a clamp, etc. The access door 1402 may be a trap door, a hatch, a cover clip, a latch, a duckbill, an access panel, a cover, etc.

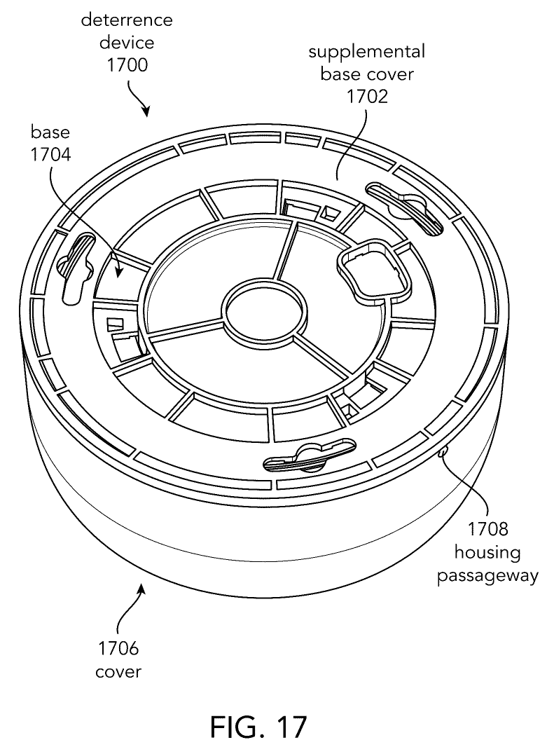

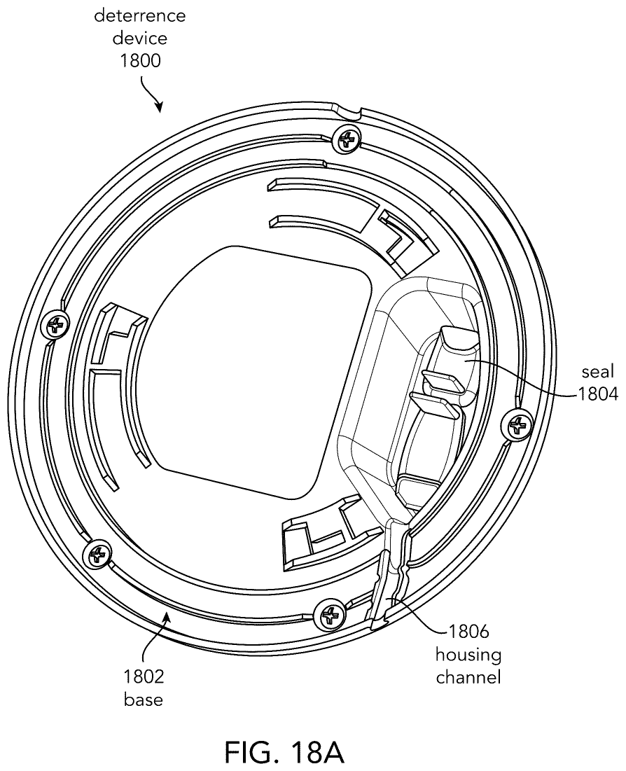

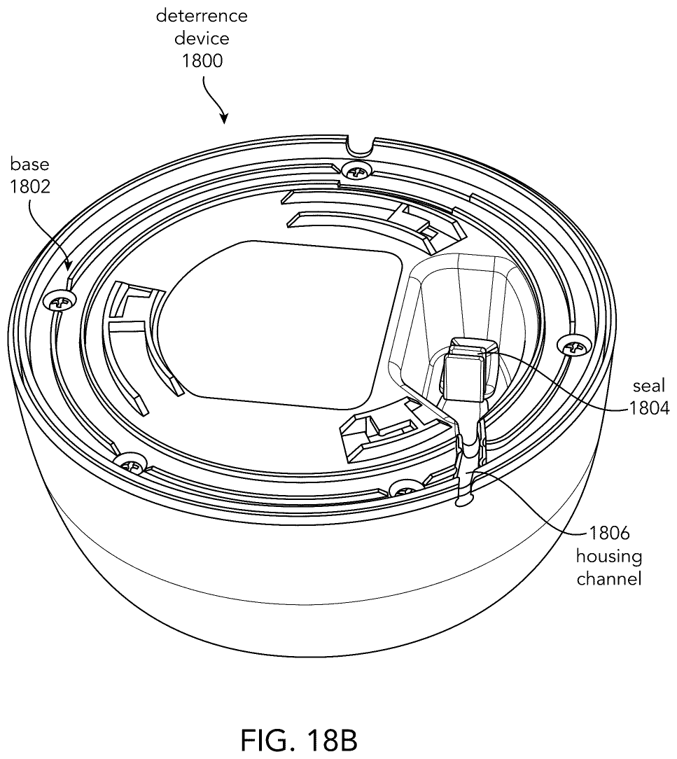

In some embodiments, the access door 1402 is configured to be hidden or disguised. For example, when the deterrence device 1400 is coupled to a surface, the access door 1402 may be hidden from plain view because it is located between the base of the deterrence device and the surface. In another example, the access door 1402 may be disguised by being hidden under seal (as shown and described in FIG. 18 below). The access door 1402 may also be hidden under the base cover (as shown in described in FIG. 17 below). Benefits of the access door 1402 being hidden or disguised may include the access door 1400 not being easily identified by a person, such as an intruder. This may facilitate the prevention of an intruder from accessing the internal components of the deterrence device 1400 and dismantling, disarming, activating, tampering, and/or it inoperable.

As shown in FIG. 14, the deterrence device 1400 includes an access door 1402 located at least partially in the center of the base 1404 and coupled to the base 1404. The access door 1402 may be coupled to the base 1404 using a hinge. In embodiments where the access door 1402 is coupled to the base 1402 using a hinge, the hinge may be hidden. In the embodiment shown in FIG. 14, the access door 1402 is securely coupled to the base 1404 using a locking screw located opposing the hidden hinges. In some embodiments, the access door 1402 is a trap door configured to hingedly couple to the base 1404 with hidden hinges and securely couple to the base 1404 with a screw at the secure point 1406.

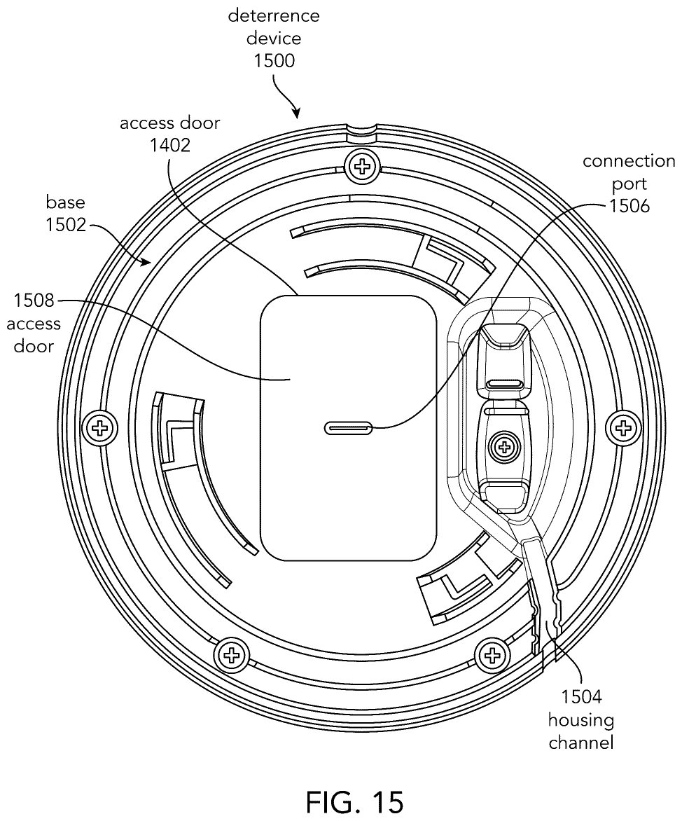

FIG. 15 illustrates a back view of the deterrence device 1500, according to some embodiments. In the embodiment as shown in FIG. 15, the base 1502 of the deterrence device 1500 may include a housing channel 1504. In additional or alternative embodiments, the housing channel 1504 includes a housing aperture. In some embodiments, the housing channel 1504 is a housing aperture. In embodiments where the housing channel 1504 includes a housing aperture or is a housing aperture, the housing aperture of the housing channel 1504 is different than the housing openings(s) (as shown and described in FIG. 13A and FIG. 13B). The housing channel 1504 may be configured to receive an external connection. In some embodiments, the external connection is a USB or a USB connector. In additional or alternative embodiments, the USB enters the housing interior (as shown and described in FIG. 5A above) through the housing channel 1504 located on the base 1502 of the deterrence device 1500. In some embodiments where the external connection is a USB or a USB connector, the USB or USB connector, is configured to couple with an internal component of the deterrence device 1500. In alternate embodiments, the USB or USB connector is not configured to couple with an internal component of the deterrence device 1500.

In some embodiments, the base 1502 includes a connection port 1506 configured to receive an external connection. In some embodiments, the connection port 1506 is a USB connection port. The connection port 1506 may be configured to couple with an internal component of the deterrence device 1500, such as the PCB or the power supply (as shown and described in FIG. 5A above). In some embodiments, the connection port 1506 is located on the access door 1508. In additional or alternative embodiments, the connection port 1506 is located at least partially in the middle of the access door 1508.

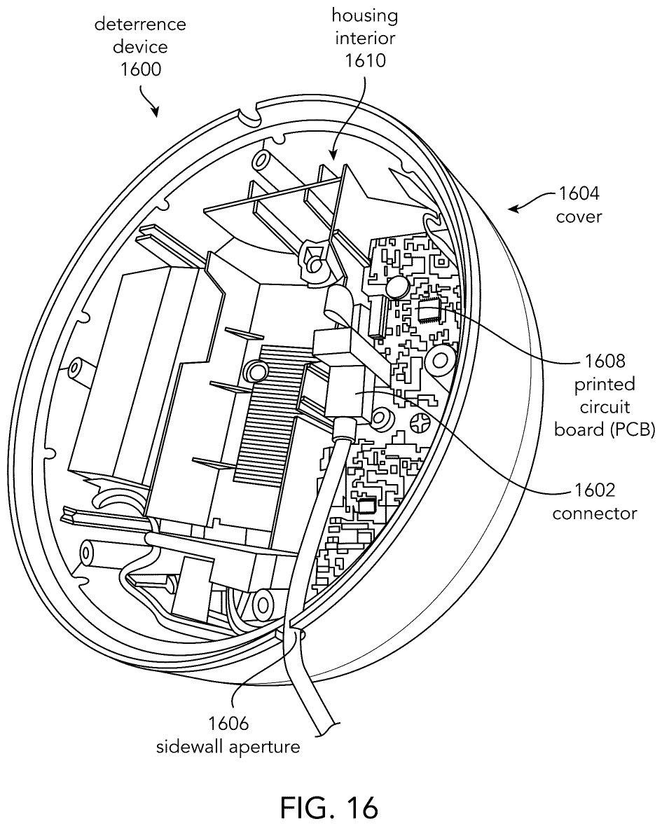

FIG. 16 illustrates a perspective view of the deterrence device 1600, according to some embodiments. In the embodiment as shown in FIG. 16, the deterrence device 1600 may include a connector 1602 configured to couple with an internal component. As shown in the embodiment of FIG. 16, the cover 1604 of the deterrence device 1600 includes a sidewall aperture 1606 configured to receive a connector 1602, such as a USB or a USB connector, where the connector 1602 couples with a PCB 1608. In some embodiments, the sidewall aperture 1606 is located at the bottom of the deterrence device 1600. Additionally, or alternatively, the sidewall aperture 1606 may be located on the bottom of the cover 1604. The connector 1602 may be configured to enter from the exterior of the deterrence device 1600 into the housing interior 1610 of the deterrence device 1600. In additional or alternative embodiments, the connector 1602 enters the housing interior 1610 of the deterrence device 1600 by way of the sidewall aperture 1606.

FIG. 17 illustrates a perspective view of the deterrence device 1700, according to some embodiments. In the embodiment as shown in FIG. 17, the deterrence device 1700 may include a supplemental base cover 1702 configured to couple with the base 1704. Benefits of the supplemental base cover 1702 coupling to the base 1704 may include shielding the base 1704 from external elements and/or allowing for the deterrence device 1700 to couple with a surface. In some embodiments, the supplemental base cover 1702 is a wall plate configured to couple the deterrence device 1700 to a surface. In the embodiment as shown in FIG. 17, the cover 1706 of the deterrence device 1700 may include a passageway 1708 configured to receive a connection, such as a USB connection. The base 1704 may couple with the cover 1706 after the connection, such as a USB, couples with a connection port (as shown and described in FIG. 15) or an internal component. The supplemental base cover 1702 may then couple with the base 1704 in a direction opposite of the cover 1706. In some embodiments, the base 1704 includes the supplemental base cover 1702, such that the base 1704 and supplemental base cover 1702 are a single unit.

In some embodiments, male coupling mechanisms and female coupling mechanisms are present and disposed about the base 1704 and/or the supplemental base cover 1702. In additional or alternative embodiments, the number of male coupling mechanisms is approximately equal in number and location to the number of female coupling mechanisms, such that the female coupling mechanisms interact with the male coupling mechanisms. It may be desirable to align the number and positioning of the male coupling mechanism with the number and positioning of the associated female coupling mechanisms. Additionally, or alternatively, the male coupling mechanism may be protrusions located about the base 1704 and/or the supplemental base cover 1702. The male coupling mechanisms may be configured to at least partially enter the female coupling mechanism. In some embodiments, the male coupling mechanisms are configured to at least partially couple with the female mechanism. In additional or alternative embodiments, the male coupling mechanism is configured to at least partially couple with a female coupling mechanism located on a surface. The male coupling mechanisms may be configured to at least partially enter the female coupling mechanism located about a surface.

FIG. 18A illustrates a perspective view of the deterrence device 1800, according to some embodiments, and FIG. 18B illustrates a perspective view thereof. In the embodiment as shown in FIG. 18A, the base 1802 may include a seal 1804. In some embodiments, the seal 1804 is configured to isolate the housing interior of the deterrence device 1800 from the external environment. In additional or alternative embodiments, the seal 1804 is a port configured to receive an external connection, such as a USB. In embodiments where the seal 1804 is a port, the port is configured to extend from the housing interior of the deterrence device 1800 to the base 1802 of the deterrence device 1800. The seal 1804 of the deterrence device 1800 may be configured to be a rubber port located on the base 1802 of the deterrence device 1800 and further configured to receive a USB entering into the housing interior, by way of a housing channel 1806. In some embodiments, the seal 1804 is configured to cover a connection port (as shown and described in FIG. 15). In additional or alternative embodiments, the seal 1804 is configured to cover an access door (as shown and described in FIG. 14 above). Additionally, or alternatively, the seal 1804 may be made of a polymer, synthetic polymer, or semi-synthetic polymer material. In some embodiments, the seal 1804 is made of a metal, transition metals, metalloids, post-transition metals, or alloys. The seal 1804 may be made of a rubber material. Additionally, or alternatively, the seal 1804 may be a packing joint, a toric joint, or a mechanical gasket. In some embodiments, the seal 1804 is an O-ring. In additional or alternative embodiments, the seal 1804 is made of aluminum. In embodiments where the seal 1804 is made of aluminum, the seal 1804 may be made of aluminum with a high-pressure connection. Additionally, or alternatively, the seal may be two pieces pressed together to form a sealed lock.

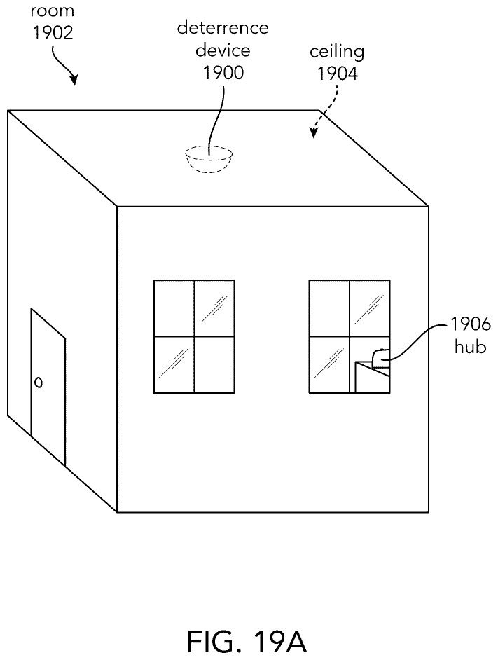

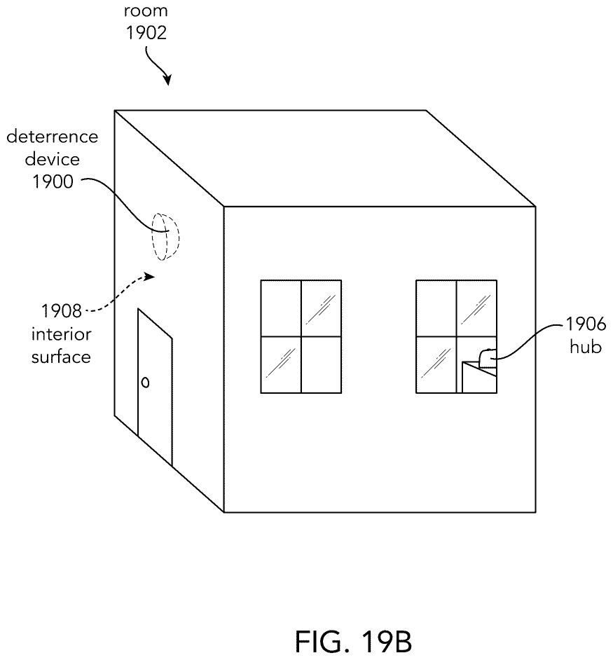

FIG. 19A illustrates a perspective view from outside of a room 1902 including a deterrence device 1900, according to some embodiments. FIG. 19B illustrates a perspective view of room 1902 including a deterrence device 1900 positioned in a different location, according to some embodiments. In the embodiment as shown in FIG. 19A, the deterrence device 1900 may be present on a ceiling 1904 of the room 1902. In some embodiments, the deterrence device 1900 is configured to couple with a surface, such that the housing opening(s) are facing towards a ground surface. In additional or alternative embodiments, the deterrence device 1900 is configured to couple with a ceiling 1902 or a roof line at the base 1904. Methods and components for coupling the deterrence device 1300 are shown and described in FIG. 17 above. Through the window is the view of a hub 1906 (as shown and described as the external component in FIG. 7 above).

Additionally, or alternatively, the deterrence device 1900 may be configured to couple or mount with an interior surface 1908 of the room 1902 and/or a building (as shown and described in FIG. 1). In some embodiments, the interior surface 1908 is a wall. In the embodiment as shown in FIG. 19B, the deterrence device 1900 is present on an interior surface 1908 of the room 1902. In some embodiments, the deterrence device 1900 is configured to couple or mount with an interior surface 1908 at the base 1904. In additional or alternative embodiments, the deterrence device 1900 is configured to couple or mount with an interior surface 1908 by way of a supplemental base cover (as shown and described in FIG. 17 above).

In some embodiments, the deterrence device 1900 is circular in shape. In additional or alternative embodiments, the deterrence device 1900 is configured to appear as (i.e., mimic, imitate, emulate, resemble, impersonate, disguise) a safety device, a fire detection device, a household safety device, or a household appliance. In some embodiments, the deterrence device 1900 is configured to appear as (i.e., mimic, imitate, emulate, resemble, impersonate, disguise) a smoke detector. Benefits of configuring the deterrence device 1900 to appear as a smoke detector may include camouflaging or visually distorting the appearance of the deterrence device 1900 so that it is not easily identified by a person, such as an intruder. This may facilitate the prevention of an intruder from dismantling, disarming, inadvertently activating, tampering, and/or rendering the deterrence device 1900 inoperable. In additional or alternative embodiments, the device is configured to blend into a background of an environment. The device may be configured to display a circular profile.

Included in the present disclosure is a device, including a housing configured to detachably couple to a surface of a building, the housing including an interior portion therewithin. In some embodiments, the device includes a container housed within the interior portion of the housing, the container containing contents therewithin. According to some embodiments, the device is configured to discharge the contents from within the container to an area exterior to the housing.

The device may be configured to discharge the contents to the area via an opening in the housing. In some embodiments, the device further includes an actuator configured to discharge the contents from within the container to the opening of the housing via an aperture of the container.

According to some embodiments, the actuator is configured to interact with the container mechanically, electrically, or both, to discharge the contents from within the container. The device may further include a motor configured to move the actuator to enable mechanical interaction between the actuator and the container. In some embodiments, the aperture of the container is aligned with the opening of the housing.

According to some embodiments, the container further includes a container body defining a reservoir therewithin containing the contents. The reservoir may have a capacity from about 0.1 ounce (oz) to about 100 oz. In some embodiments, the container further includes a nozzle extending to the opening of the housing, the nozzle having an outlet opening aligned with the opening of the housing, such that the contents are configured to pass through the nozzle from the reservoir to the opening of the housing. According to some embodiments, the aperture is disposed on the container body and spaced from the opening of the housing, such that the nozzle extends substantially between the aperture and the opening of the housing. The nozzle may include the aperture. In some embodiments, the outlet opening of the nozzle is the aperture.

According to some embodiments, the device further includes a valve stem fluidly coupled with the aperture, wherein the valve stem, the container body, or both, is configured to move between a first position and a second position, wherein in the first position the reservoir is fluidly isolated from the opening of the housing, wherein in the second position the valve stem fluidly couples the reservoir with the opening of the housing. The valve stem, the container body, or both, may move between the first and second positions via the interaction between the actuator and the container.

In some embodiments, the container further includes a cap mechanically coupled to the container body, the valve stem at least partially disposed within the cap, the container body, or both. According to some embodiments, the actuator is configured to move the container body towards the cap so as to move the container body from the first position to the second position, thereby fluidly coupling the reservoir with the opening of the housing. The container may further include a lever mechanically coupled to the container body, wherein the actuator is configured to move the lever toward the container body so as to move the valve stem from the first position to the second position, thereby fluidly coupling the reservoir with the opening of the housing.

In some embodiments, the container is pressurized. According to some embodiments, a pressure within the container is from about 25 pounds per square inch (PSI) to about 200 PSI. The device may further include a pump coupled to the container and configured to dispense contents from the container.

The device may further include a heating plate configured to maintain a temperature of i) the contents within the container, ii) the interior portion of the housing, or both. In some embodiments, the heating plate includes a metal oxide semiconductor (MOS) heater, a flat plate collector (FPC) heating plate, or both. According to some embodiments, the temperature is maintained above about −10° Celsius (C), −5° C., 0° C., 5° C., 10° C., or 15° C. The heating plate may be limited to less than 40° C. The device may include a heating pad, either alone or in combination with the heating plates as detailed above. Additionally, or alternatively, the heating plate may also serve to keep the contents of any present container at an optimal temperature for fluidity and dispersion upon egress from the deterrence device without exceeding a high temperature that could pose a hazard, permitting the deterrence device to operate in suboptimal conditions.

In some embodiments, the contents are configured to irritate a sensory organ of an individual. According to some embodiments, the contents include a chemical composition. The chemical composition may include capsaicin. In some embodiments, the chemical composition is approximately two million Scoville heat units (SHUS).

According to some embodiments, the chemical composition is configured to aerosolize upon egressing the aperture, the opening of the housing, or both. The aerosolized chemical composition may be configured to remain in the area for a predetermined amount of time. In some embodiments, the predetermined amount of time is from approximately zero minutes to approximately thirty minutes. According to some embodiments, the area is approximately fifteen hundred square feet. The aerosolized chemical composition may be configured to degrade after the predetermined amount of time. In some embodiments, the degradation includes a removal of an irritant to a sensory organ from the area.

According to some embodiments, the housing includes a cover and a base detachably coupled to the cover, the cover and the base substantially enclosing the interior portion of the housing. The opening of the housing may be disposed on the cover. In some embodiments, the base is configured to detachably couple to the surface of the building, such that the cover is configured to be removable from the base while the base remains coupled to the surface of the building.

According to some embodiments, the surface is selected from the group consisting of a ceiling of the building, a roof of the building, an exterior wall of the building, an interior wall of the building, and combinations thereof. The container may be removable from the housing. In some embodiments, the container is refillable.

According to some embodiments, the device further includes a printed circuit board (PCB) housed within the interior portion of the housing. The PCB may be electrically coupled, communicatively coupled, or both, with the actuator, the motor, or both, such that discharge of the contents from within the container via interaction between the actuator and the container is based on instructions received via the PCB.

In some embodiments, the device further includes a light emitting diode (LED) electrically coupled, communicatively coupled, or both to the PCB, the LED configured to emit a light visible from an exterior of the housing. According to some embodiments, the LED is configured to pulse. The LED may be a first LED, the device further including a second LED.

In some embodiments, the device further includes a speaker electrically coupled, communicatively coupled, or both to the PCB, the speaker configured to emit a noise audible from the exterior of the housing. According to some embodiments, the noise is selected from the group consisting of a siren, a message, and combinations thereof.

The device may further include a camera electrically coupled, communicatively coupled, or both to the PCB, the camera configured to capture an image or video of a location exterior to the housing. In some embodiments, the device further includes a motion detector electrically coupled, communicatively coupled, or both to the PCB, the motion detector configured to capture a movement exterior to the housing. According to some embodiments, the device further includes a microphone electrically coupled, communicatively coupled, or both to the PCB, the microphone configured to capture a sound exterior to the housing. The device may include any combination of these features.

The PCB may be configured to control an action selected from the group consisting of emitting the light from the LED, emitting the noise from the speaker, releasing the contents from the container, capturing the image or video of the location exterior to the housing, capturing the movement exterior to the housing, capture the sound exterior to the housing, and combinations thereof.

In some embodiments, the action is a first action, the PCB further configured to control a second action. According to some embodiments, the PCB is configured to control a sequential order of the first action and the second action. The PCB may be configured to control a delay between the first action and the second action.

In some embodiments, the PCB is configured to control a duration of the action. According to some embodiments, the action is releasing the contents from the container, the duration lasting until the container is approximately empty. The duration may be approximately three seconds. The duration may be greater than three seconds.

In some embodiments, the device further includes a power supply coupled to a component selected from the group consisting of the actuator, the motor, the PCB, the LED, the speaker, the camera, the microphone, the motion detector, and combinations thereof. According to some embodiments, the power supply is sized and configured to fit inside the interior portion of the housing. The power supply may be a battery. In some embodiments, the battery is a lithium-ion battery.

According to some embodiments, the power supply is configured to couple to an external outlet. The device may further include a power indicator. In some embodiments, the power indicator is configured to indicate a power state of the power supply.

According to some embodiments, the device is further configured to communicate with an external component. The external component may include a remote computing device. In some embodiments, the remote computing device includes a device selected from the group consisting of a smart device, a tablet computer, a personal assistant, a distributed network of servers, and combinations thereof.

According to some embodiments, the remote computing device is configured to provide instructions for the PCB to control an action, such as those detailed above. The remote computing device may be configured to provide instructions to discharge the contents from within the container to the area exterior of the housing.

In some embodiments, the external component includes a doorbell. According to some embodiments, the external component includes another device of a same type. The device may be configured to communicate with the external component via a wired connection. In some embodiments, the device is configured to communicate with the external component via a wireless connection.

Also included in the present disclosure is a system, including a device, such as those detailed above. In some embodiments, the system includes an external component, such as those detailed above, the external component communicatively coupled to the device.

According to some embodiments, external component is configured to receive an alert from the device, such that the external component is configured to activate a deterrence measure via the device. The deterrence measure may be i) discharging the contents from within the container to the are exterior to the housing, ii) emitting light from the LED, ii) emitting noise from the speaker, ii) capturing image via the camera, or iv) any combination thereof. In some embodiments, the deterrence measure includes discharging the contents from within the container to the area exterior to the housing.

According to some embodiments, the alert includes light being emitted from the LED, sound received by the microphone, movement captured by the motion detector, image captured by the camera, or any combination thereof. The external component may be configured to automatically activate the deterrence measure.

In some embodiments, the external component is configured to activate the deterrence measure based on a user input. According to some embodiments, the external component includes a casing configured to detachably couple to the surface of the building or a different surface of the building.

The device may be a first device, and the system may further include a second device. In some embodiments, the external component is communicatively coupled to each of the first device and the second device. According to some embodiments, the external component is configured to independently control, simultaneously control, or both, an action for each of the first device and the second device.

The external component may further include a screen. In some embodiments, the screen is configured to provide information to a user. According to some embodiments, the information includes a status of each device communicatively coupled with the external component. The status may relate to i) the container and contents therewithin for each device, ii) the power supply for each device, iii) connectivity of each device, or iv) any combination thereof.

In some embodiments, the information is selected from the group consisting of an image taken by the camera, a video taken by the camera, a motion detected by the motion detector, and combinations thereof.

According to some embodiments, the screen is configured to receive the user input. The user input may include pressing the screen for a predetermined duration to activate a deterrence measure. In some embodiments, the user input includes i) selectively activating the deterrence measure for any device communicatively coupled with the external component, ii) activating the deterrence measure for all devices communicatively coupled with the external component, or iii) both.

In some embodiments, the system further includes a computational module communicatively coupled to the external component, the LED, the speaker, the actuator, the motor, the camera, the microphone, or any combination thereof. According to some embodiments, the computational module includes a machine learning algorithm configured to determine a future output by the external component based on a previous output by the external component in response to a categorized alert, wherein the categorized alert is an alert classified according to an identifying parameter.

The future output, previous output, or both, may include the activation of a deterrence measure by the device. In some embodiments, for a categorized alert relating to the image captured by the camera, the identifying parameter includes i) a threshold level of a number of persons present in the image, ii) facial features, such that the computational module is configured to determine the future output via facial recognition, iii) a type of animal, iv) a weapon, or v) any combination thereof.

According to some embodiments, for a categorized alert relating to the motion captured by the motion detector, the identifying parameter includes motion during a specified time. For a categorized alert relating to the sound captured by the microphone, the identifying parameter may be i) a threshold level of a number of different individuals present in the captured sound, ii) vocal features, such that the computational module is configured to determine the future output via vocal recognition, iii) a sound associated with a type of animal, iv) a sound associated with a weapon, or v) any combination thereof.

In some embodiments, the computational module associates each categorized alert according to a threat level. According to some embodiments, the computational module is located remote to the device, the external component, or both. The computational module may be disposed within the device or the external component.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

The term “substantially” used herein, unless specifically stated otherwise, or otherwise understood within the context as used, is generally intended to convey “substantially” as greater than or equal to half.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A device, comprising:
a housing configured to detachably couple to a surface of a building, the housing comprising a housing exterior and a housing interior therewithin;
a container housed within the housing interior, the container containing contents therewithin; and
at least one housing opening located on the housing exterior,
wherein the device is configured to discharge the contents from within the container to an area exterior to the housing, via at least one housing opening.

2. A device, comprising:
a housing configured to detachably couple to a surface of a building, the housing comprising a housing exterior and a housing interior therewithin;
a container housed within the housing interior, the container containing contents therewithin; and
a plurality of housing openings located on the housing exterior,
wherein the device is configured to discharge the contents from within the container to an area exterior to the housing via the plurality of housing openings,
wherein the device is configured to spray in a pattern when the device discharges the contents from within the container, via the plurality of housing openings and
wherein each of the housing openings of the plurality of housing openings is configured to i) individually spray unique patterns, ii) spray the same pattern, iii) spray customizable patterns, or iv) combinations thereof.

3. A device, comprising:
a housing configured to detachably couple to a surface of a building, the housing comprising a housing interior therewithin;
a container housed within the housing interior, the container containing contents therewithin; and
the housing comprising a channel coupled to the container,
wherein the device is configured to discharge the contents from within the container to an area exterior to the housing, and
wherein the channel is configured to facilitate the device discharging the contents from within the container to an area exterior to the housing.

4. A device, comprising:
a housing configured to detachably couple to a surface of a building, the housing comprising a housing interior therewithin;
a container housed within the housing interior, the container containing contents therewithin; and
the housing comprising i) a plurality of channels, ii) a branching flowpath channel, or iii) a multipath channel,
wherein the device is configured to discharge the contents from within the container to an area exterior to the housing, and
wherein i) the plurality of channels, ii) the branching flowpath channel, or iii) the multipath channel is configured to facilitate the device discharging the contents from within the container to an area exterior to the housing.

5. A device, comprising:
a housing configured to detachably couple to a surface of a building, the housing comprising a housing interior therewithin;
a container housed within the housing interior, the container containing contents therewithin; and
a channel coupled to the container,
wherein the device is configured to discharge the contents from within the container to an area exterior to the housing, and
wherein the channel is configured to withstand a maximum emission pressure the container emits when the device discharges the contents from within the container to an area exterior to the housing.

6. A device, comprising:
a housing configured to detachably couple to a surface of a building, the housing comprising a housing interior therewithin;
an access door located on the housing; and
a container housed within the housing interior, the container containing contents therewithin,
wherein the access door is configured to i) expose, ii) provide access, or iii) combinations thereof to at least a portion of the housing interior, and
wherein the device is configured to discharge the contents from within the container to an area exterior to the housing.

7. A device, comprising:
a housing configured to detachably couple to a surface of a building, the housing comprising a base and a housing interior therewithin;
a container housed within the housing interior, the container containing contents therewithin; and
an access door coupled to the base,
wherein the access door is configured to expose at least a portion of the housing interior
wherein the access door is further configured to couple to the base at a secure point, via a coupling mechanism, and
wherein the device is configured to discharge the contents from within the container to an area exterior to the housing.

8. A device, comprising:
a housing configured to detachably couple to a surface of a building, the housing comprising a housing interior therewithin;
a container housed within the housing interior, the container containing contents therewithin; and
an access door configured to be i) hidden, ii) disguised, or iii) combinations thereof,
wherein the device is configured to discharge the contents from within the container to an area exterior to the housing.

9. A device, comprising:
a housing configured to detachably couple to a surface of a building, the housing comprising a base and a housing interior therewithin;
a container housed within the housing interior, the container containing contents therewithin; and
a connection port located at least partially on i) the housing, or ii) the base,
wherein the connection port is configured to i) receive an external connection, ii) couple with an internal component, iii) couple an external connector with an internal component, or iv) combinations thereof, and
wherein the device is configured to discharge the contents from within the container to an area exterior to the housing.

10. A device, comprising:
a housing configured to detachably couple to a surface of a building, the housing comprising an access door and a housing interior therewithin;
a container housed within the housing interior, the container containing contents therewithin; and
a connection port located at least partially on the access door,
wherein the device is configured to discharge the contents from within the container to an area exterior to the housing.

11. A device, comprising:
a housing configured to detachably couple to a surface of a building, the housing comprising a housing interior therewithin;
a container housed within the housing interior, the container containing contents therewithin; and
a housing channel located substantially on the housing,
wherein the housing channel is configured to i) receive an external connection, ii) couple to an internal component, iii) couple the external connection to an internal component, or iv) combinations thereof, and
wherein the device is configured to discharge the contents from within the container to an area exterior to the housing.

12. A device, comprising:
a housing configured to detachably couple to a surface of a building, the housing comprising a housing interior therewithin;
a container housed within the housing interior, the container containing contents therewithin; and
a sidewall aperture located on the housing
wherein the sidewall aperture is configured to i) receive a connector, ii) receive an external connection, iii) couple to an internal component, iv) couple the connector to an internal component, v) couple the external connection to an internal component, or vi) combinations thereof, and
wherein the device is configured to discharge the contents from within the container to an area exterior to the housing.

13. A device, comprising:
a housing configured to detachably couple to a surface of a building, the housing comprising a base and a housing interior therewithin;
a container housed within the housing interior, the container containing contents therewithin; and
a supplemental base cover configured to detachably couple with i) the base, ii) the housing, or iii) combinations thereof,
wherein the device is configured to discharge the contents from within the container to an area exterior to the housing.

14. A device, comprising:
a housing configured to detachably couple to a surface of a building, the housing comprising a base and a housing interior therewithin;
a container housed within the housing interior, the container containing contents therewithin; and
a supplemental base cover comprising i) male coupling mechanisms, ii) female coupling mechanisms, or iii) combinations thereof,
wherein the device is configured to discharge the contents from within the container to an area exterior to the housing.

15. A device, comprising:
a housing configured to detachably couple to a surface of a building, the housing comprising a housing interior therewithin;
a container housed within the housing interior, the container containing contents therewithin; and
a housing passageway located on the housing,
wherein the housing passage way is configured to i) receive an external connection, ii) couple to an internal component, iii) couple the connector to an internal component, iv) couple the external connection to an internal component, or v) combinations thereof, and
wherein the device is configured to discharge the contents from within the container to an area exterior to the housing.

16. A device, comprising:
a housing configured to detachably couple to a surface of a building, the housing comprising a housing interior therewithin;
a container housed within the housing interior, the container containing contents therewithin;
a supplemental base cover detachably coupled to the housing; and
a housing passageway located on the housing,
wherein the device is configured to discharge the contents from within the container to an area exterior to the housing.

17. A device, comprising:
a housing configured to detachably couple to a surface of a building, the housing comprising a base and a housing interior therewithin;
a container housed within the housing interior, the container containing contents therewithin; and
a seal located i) at least partially on the base, ii) the housing interior, iii) the housing, or iv) combinations thereof,
wherein the seal is configured to i) receive an external connection, ii) isolate the housing interior from an area exterior to the housing, iii) couple to an internal component, iv) couple an external connection to an internal component, or v) combinations thereof, and
wherein the device is configured to discharge the contents from within the container to the area exterior to the housing.

18. A device, comprising:
a housing configured to detachably couple to a surface of a building, the housing comprising a housing interior therewithin; and
a container housed within the housing interior, the container containing contents therewithin,
wherein the device is configured to discharge the contents from within the container to an area exterior to the housing, and
wherein the device is configured to mimic the appearance of a smoke detector.

19. A device, comprising:
a housing configured to detachably couple to a surface of a building, the housing comprising a housing interior therewithin; and
a container housed within the housing interior, the container containing contents therewithin,
wherein the device is configured to discharge the contents from within the container to an area exterior to the housing, and
wherein the device is configured to couple to i) a surface, ii) a ceiling, iii) a sidewall, or iv) combinations thereof.

20. The device of any of claims 3-19, wherein the device is configured to discharge the contents to the area via at least one housing opening.

21. The device of any of claim 1, 2, or 20, further comprising an actuator configured to discharge the contents from within the container to at least one housing opening, via an aperture of the container.

22. The device of claim 21, wherein the actuator is configured to interact with the container mechanically, electrically, or both, to discharge the contents from within the container.

23. The device of claim 21 or 22, further comprising a motor configured to move the actuator to enable mechanical interaction between the actuator and the container.

24. The device of any of claims 21-23, wherein the aperture of the container is aligned with at least one housing opening.

25. The device of any of claims 21-23, wherein the container further comprises a container body defining a reservoir therewithin containing the contents.

26. The device of claim 25, wherein the reservoir has a capacity from about 0.1 ounce (oz) to about 100 oz.

27. The device of claim 25 or 26, wherein the container further comprises a nozzle extending to at least one housing opening, the nozzle having an outlet opening aligned with at least one housing opening such that the contents are configured to pass through the nozzle from the reservoir to at least one housing opening.

28. The device of claim 27, wherein the aperture is disposed on the container body and spaced from at least one housing opening, such that the nozzle extends substantially between the aperture and at least one housing opening.

29. The device of claim 27, wherein the nozzle comprises the aperture.

30. The device of claim 29, wherein the outlet opening of the nozzle is the aperture.

31. The device of any of claims 20-30, further comprising a valve stem fluidly coupled with the aperture, wherein the valve stem, the container body, or both, is configured to move between a first position and a second position, wherein in the first position the reservoir is fluidly isolated from at least one housing opening, wherein in the second position the valve stem fluidly couples the reservoir with at least one housing opening.

32. The device of claim 31, wherein the valve stem, the container body, or both, moves between the first and second positions via the interaction between the actuator and the container.

33. The device of claim 31 or 32, wherein the container further comprises a cap mechanically coupled to the container body, the valve stem at least partially disposed within the cap, the container body, or both.

34. The device of claim 33, wherein the actuator is configured to move the container body towards the cap so as to move the container body from the first position to the second position, thereby fluidly coupling the reservoir with at least one housing opening.

35. The device of claim 31 or 32, wherein the container further comprises a lever mechanically coupled to the container body, wherein the actuator is configured to move the lever toward the container body so as to move the valve stem from the first position to the second position, thereby fluidly coupling the reservoir with at least one housing opening.

36. The device of any of claims 1-35, wherein the container is pressurized.

37. The device of claim 36, wherein a pressure within the container is from about 25 pounds per square inch (PSI) to about 200 PSI.

38. The device of any of claims 1-37, further comprising a pump coupled to the container and configured to dispense contents from the container.

39. The device of any of claims 1-38, further comprising a heating plate configured to maintain a temperature of i) the contents within the container, ii) the housing interior, or iii) both.

40. The device of claim 39, wherein the heating plate comprises a metal oxide semiconductor (MOS) heater, a flat plate collector (FPC) heating plate, or both.

41. The device of claim 39 or 40, wherein the temperature is maintained above about −10° celsius (C), −5° C., 0° C., 5° C., 10° C., or 15° C.

42. The device of any of claims 39-41, wherein the heating plate is limited to less than 40° C.

43. The device of any one of claims 1-42, wherein the contents are configured to irritate a sensory organ of an individual.

44. The device of claim 43, wherein the contents comprise a chemical composition.

45. The device of claim 43, wherein the chemical composition comprises capsaicin.

46. The device of claim 43, wherein the chemical composition is approximately two million Scoville heat units (SHUS).

47. The device of any of claims 44-46, wherein the chemical composition is configured to aerosolize upon egressing the aperture, at least one housing opening, or both.

48. The device of claim 47, wherein the aerosolized chemical composition is configured to remain in the area for a predetermined amount of time.

49. The device of claim 48, wherein the predetermined amount of time is from approximately zero minutes to approximately thirty minutes.

50. The device any of claims 47-49, wherein the area is approximately fifteen hundred square feet.

51. The device of any of claims 47-50, wherein the aerosolized chemical composition is configured to degrade after the predetermined amount of time.

52. The device of claim 51, wherein the degradation comprises a removal of an irritant to a sensory organ from the area.

53. The device of any of claims 1-52, wherein the housing comprises a cover and a base detachably coupled to the cover, the cover and the base substantially enclosing the housing interior.

54. The device of claim 52 or 53, wherein at least one housing opening is disposed on the cover.

55. The device of any of claims 52-54, wherein the base is configured to detachably couple to the surface of the building, such that the cover is configured to be removable from the base while the base remains coupled to the surface of the building.

56. The device of any of claims 1-55, wherein the surface is selected from the group consisting of a ceiling of the building, a roof of the building, an exterior wall of the building, an interior wall of the building, and combinations thereof.

57. The device of any of claims 1-56, wherein the container is removable from the housing.

58. The device of any of claims 1-57, wherein the container is refillable.

59. The device of any of claims 1-58, further comprising a printed circuit board (PCB) housed within the housing interior.

60. The device of claim 59, wherein the PCB is electrically coupled, communicatively coupled, or both, with the actuator, the motor, or both, such that discharge of the contents from within the container via interaction between the actuator and the container is based on instructions received via the PCB.

61. The device of claim 59 or 60, further comprising a light emitting diode (LED) electrically coupled, communicatively coupled, or both to the PCB, the LED configured to emit a light visible from an exterior of the housing.

62. The device of claim 61, wherein the LED is configured to pulse.

63. The device of claim 61 or 62, wherein the LED is a first LED, the device further comprising a second LED.

64. The device of any of claims 59-63, further comprising a speaker electrically coupled, communicatively coupled, or both to the PCB, the speaker configured to emit a noise audible from the exterior of the housing.

65. The device of claim 64, wherein the noise is selected from the group consisting of a siren, a message, and combinations thereof.

66. The device of any of claims 1-65, further comprising a camera electrically coupled, communicatively coupled, or both to the PCB, the camera configured to capture an image or video of a location exterior to the housing.

67. The device of any of claims 1-66, further comprising a motion detector electrically coupled, communicatively coupled, or both to the PCB, the motion detector configured to capture a movement exterior to the housing.

68. The device of any of claims 1-67, further comprising a microphone electrically coupled, communicatively coupled, or both to the PCB, the microphone configured to capture a sound exterior to the housing.

69. The device of any of claims 59-68, wherein the PCB is configured to control an action selected from the group consisting of emitting the light from the LED, emitting the noise from the speaker, releasing the contents from the container, capturing the image or video of the location exterior to the housing, capturing the movement exterior to the housing, capture the sound exterior to the housing, and combinations thereof.

70. The device of claim 69, wherein the action is a first action, the PCB further configured to control a second action.

71. The device of claim 70, wherein the PCB is configured to control a sequential order of the first action and the second action.

72. The device of claim 70 or 71, wherein the PCB is configured to control a delay between the first action and the second action.

73. The device of any of claims 69-72, wherein the PCB is configured to control a duration of the action.

74. The device of claim 73, wherein the action is releasing the contents from the container, the duration lasting until the container is approximately empty.

75. The device of claim 73 or 74, the duration comprising approximately three seconds.

76. The device of any of claims 1-75, further comprising a power supply coupled to a component selected from the group consisting of the actuator, the motor, the PCB, the LED, the speaker, the camera, the microphone, the motion detector, and combinations thereof.

77. The device of claim 76 wherein the power supply is sized and configured to fit inside the housing interior.

78. The device of claim 77, wherein the power supply is a battery.

79. The device of claim 78, wherein the battery is a lithium-ion battery.

80. The device of any of claims 76-79, wherein the power supply is configured to couple to an external outlet.

81. The device of any of claims 76-80, further comprising a power indicator.

82. The device of claim 81, wherein the power indicator is configured to indicate a power state of the power supply.

83. The device of any of claims 1-82, further configured to communicate with an external component.

84. The device of claim 83, wherein the external component comprises a remote computing device.

85. The device of claim 84, wherein the remote computing device comprises a device selected from the group consisting of a smart device, a tablet computer, a personal assistant, a distributed network of servers, and combinations thereof.

86. The device of any of claims 82-85, wherein the remote computing device is configured to provide instructions for the PCB to control the action of any of claims 69-75.

87. The device of any of claims 82-86, wherein the remote computing device is configured to provide instructions to discharge the contents from within the container to the area exterior of the housing.

88. The device of any of claims 82-87, wherein the external component comprises a doorbell.

89. The device of any of claims 82-87, wherein the external component comprises another device of a same type.

90. The device of any of claims 82-87, wherein the device is configured to communicate with the external component via a wired connection.

91. The device of any of claims 82-87, wherein the device is configured to communicate with the external component via a wireless connection.
